(19) United States
(12) Patent Application Publication
(10) Pub. No.: US 2016/0007011 A1
(43) Pub. Date: Jan. 7, 2016

(54) STEREOSCOPIC IMAGE DISPLAY DEVICE

(71) Applicant: NLT Technologies, Ltd., Kanagawa (JP)

(72) Inventors: Yoshihiro NONAKA, Kanagawa (JP); Takefumi HASEGAWA, Kanagawa (JP); Koji SHIGEMURA, Kanagawa (JP)

(21) Appl. No.: 14/789,318

(22) Filed: Jul. 1, 2015

(30) Foreign Application Priority Data
Jul. 1, 2014 (JP) 2014-136248

(51) Int. Cl. H04N 13/04; H04N 7/015

(52) U.S. Cl. CPC H04N 13/0404; H04N 13/0409; H04N 13/0447; H04N 7/0155; H04N 13/0486

(57) ABSTRACT

A stereoscopic image display device includes sub-pixels corresponding to N-viewpoints (N is a natural number of 3 or higher), wherein: an “X−1”th viewpoint sub-pixel is connected to an image signal source via a corresponding signal line; an “X+1”th viewpoint sub-pixel is connected to the image signal source via a signal line that is different from the signal line corresponding to the “X−1”th viewpoint sub-pixel; voltages corresponding to a prescribed image signal are written and held to the “X−1”th viewpoint sub-pixel and the “X+1”th viewpoint sub-pixel; and a voltage generated by a pixel voltage generating module by using the voltages written to the “X−1”th viewpoint sub-pixel and to the “X+1”th viewpoint sub-pixel is written to the Xth-viewpoint sub-pixel.

### CROSS-REFERENCE TO RELATED APPLICATION

This application is based upon and claims the benefit of priority from Japanese patent application No. 2014-136248, filed on Jul. 1, 2014, the disclosure of which is incorporated herein in its entirety by reference.

### BACKGROUND OF THE INVENTION

1. Field of the Invention

The present invention relates to a stereoscopic image display device. More specifically, the present invention relates to a stereoscopic image display device which displays multi-viewpoint stereoscopic images and a generation processing method of the multi-viewpoint stereoscopic images.

2. Description of the Related Art

Recently, television sets capable of viewing stereoscopic images are on the market. Accordingly, the amount of the stereoscopic image content is increasing and the environments for viewing the stereoscopic images are becoming prepared to be in good conditions. With a stereoscopic image television set, an observer generally wears eyeglasses used for stereoscopic image display for allowing the observer to view the stereoscopic images by projecting images of different parallaxes to the left and right eyes. However, there are many observers who feel a sense of discomfort to wear the eyeglasses for stereoscopic image display, and stereoscopic image display devices requiring no eyeglasses are desired. Further, when the eyeglass-type stereoscopic image display device is utilized for mobile-use, the stereoscopic image display device and the eyeglasses for stereoscopic image display need to be carried along when going out. The stereoscopic image display devices requiring no eyeglasses are desired more strongly for the mobile-use.

With the stereoscopic image display device requiring no eyeglasses for stereoscopic image display, it is a typical method to project images of different parallaxes to the left and right eyes of the observer by dividing a spatial region for projecting a stereoscopic image and projecting image of different parallaxes to each of the divided spatial regions. Through providing a lenticular lens or a parallax barrier to the stereoscopic display panel of the stereoscopic image display device, images of different parallaxes are projected to each of the divided spatial regions.

With those stereoscopic image display devices, it is also possible to divide the spatial regions to be divided into a still larger number of regions by the optical design of the lenticular lens and the parallax barrier and to project multi-viewpoint images of different viewpoint positions for each of the spatial regions. Thereby, the multi-viewpoint images according to the viewpoint positions of the observer are projected from the stereoscopic image display device even when the observer moves, so that it is possible to display a stereoscopic image as if the stereoscopic object is actually in front of the observer. This phenomenon is called motion parallax. The effect of motion parallax is improved more as the number of viewpoints for projecting the multi-viewpoint images is increased by increasing the number of divided spatial regions, so that a stereoscopic image that is still closer to the actual stereoscopic object can be displayed.

The stereoscopic image content used for broadcasting is often viewpoint images of small number of viewpoints, typically stereo-images (2-viewpoints) (referred to as plural-viewpoint images hereinafter), and multi-viewpoint image content of a larger number of viewpoints than the plural-viewpoint image is not being spread. Thus, it is necessary to generate a multi-viewpoint image of a larger number of viewpoints than the viewpoints of the plural-viewpoint image from the plural-viewpoint image acquired by the stereoscopic image display device. As the processing for generating the multi-viewpoint image of a larger number of viewpoints than the viewpoints of the plural-viewpoint image, various techniques such as CG rendering and LR high-function algorithm are disclosed. An example of the typical multi-viewpoint image generating processing may be a case where: first, corresponding points between plural-viewpoint images acquired by the stereoscopic image display device is searched and parallax values are detected; then a new viewpoint image is generated by adjusting the detected parallax values; and lastly, an image region hidden behind an object as a 3D content in the original plural-viewpoint image appears as a blank image on the new viewpoint image by the new viewpoint image generating processing, so that a multi-viewpoint image can be generated by interpolating the blank image. As the number of viewpoints increases, the processing content of the multi-viewpoint image generating processing is increased and the load is imposed upon the stereoscopic image display device. Thus, if the image signal source within the stereoscopic image display device is a generally spread (cheap) image signal source, the multi-viewpoint image generating processing cannot be performed on a real time basis. Note here that the image signal source indicates a module which receives a plural-viewpoint image acquired by the stereoscopic image display device and transmits pixel voltage information to the pixel matrix which constitutes the stereoscopic display screen within the stereoscopic image display device.

In order to overcome the above-mentioned issue, a technique for lightening the load of the image signal source of the stereoscopic image display device by lightening the multi-viewpoint image generating processing is required. Regarding the technique for lightening the multi-viewpoint image generating processing, following technical content is disclosed.

WO 2012/077420 (Patent Document 1) discloses a technique for lightening the multi-viewpoint image generating processing by calculating a luminance differential signal of plural-viewpoint images acquired by a stereoscopic image display device, and adding/subtracting the luminance differential signal to/from the plural-viewpoint image to generate a new viewpoint image.

Japanese Unexamined Patent Publication 2012-010084 (Patent Document 2) discloses a technique for lightening the multi-viewpoint image generating processing by referring to a parallax histogram of a plural-viewpoint image and image-shifting the plural-viewpoint image to the left and right lateral direction to generate a new viewpoint image.

When the number of viewpoints of the multi-viewpoint image is increased, the content of the multi-viewpoint image generating processing is increased as well with the stereoscopic image display device. Thus, the increase in the system load and the cost due to the use of the high-function algorithm is an issue. Further, it is an issue of the stereoscopic image display device using a cheap image signal source that the multi-viewpoint image cannot be generated on a real time basis.

As the methods for overcoming such issues, Patent Documents 1 and 2 are disclosed. With the techniques disclosed in Patent Documents 1 and 2, the processing content can be lightened than the typical multi-viewpoint image generating processing. However, as the number of viewpoints of the multi-viewpoint image increases, the generating processing content is increased and the load is imposed upon the image signal source of the stereoscopic image display processing device. Thus, there is such an issue that the multi-viewpoint image cannot be generated on a real time basis. Further, with the techniques disclosed in Patent Documents 1 and 2, the multi-viewpoint pixel voltage information to be transmitted from the image signal source to the pixel matrix constituting the stereoscopic image display screen is required for all the multi-viewpoint pixels. Thus, the issue of increase in the number of voltage outputs of the image signal source in accordance with the number of viewpoints still remains.

With the multi-viewpoint image generating processing of Patent Document 1, it is necessary to perform the processing for calculating the luminance differential signal from a plural-viewpoint image and adding/subtracting it. The number of luminance differential signal calculation processing and adding/subtracting processing increases as the number of viewpoints increases, so that the multi-viewpoint image generating processing cannot be performed on a real time basis when the number of viewpoints increases.

With the multi-viewpoint image generating processing of Patent Document 2, the image shift amount of the plural-viewpoint images is set by referring to the parallax histogram between the plural-viewpoint images. Thus, parallax histogram calculation processing is required. The load upon the image signal source is high with the parallax histogram calculation processing. Further, the number of processing for calculating the image shift amount from the parallax histogram increases as the number of viewpoints increases, so that the multi-viewpoint image generating processing cannot be performed on a real time basis when the number of viewpoint increases.

It is therefore an exemplary object of the present invention to overcome the aforementioned issues and to provide a stereoscopic image display device capable of generating and displaying multi-viewpoint images of a still larger number of viewpoints from acquired plural-viewpoint images even with the stereoscopic image display device that is provided with a cheap image processing arithmetic calculation unit.

### SUMMARY OF THE INVENTION

The stereoscopic image display device according to an exemplary aspect of the invention includes pixels each having N-pieces (N is a natural number satisfying N≧3) of sub-pixels corresponding to N-pieces of viewpoints arranged in matrix, wherein: an “X−1”th viewpoint sub-pixel that is one stage before an Xth-viewpoint sub-pixel (X is a natural number satisfying 2≦X≦N−1) is connected to an image signal source via a corresponding signal line; an “X+1”th viewpoint sub-pixel that is one stage after the Xth-viewpoint sub-pixel is connected to the image signal source via a signal line that is different from the signal line corresponding to the “X−1”th viewpoint sub-pixel; voltages corresponding to a prescribed image signal are written and held to the “X−1”th viewpoint sub-pixel and the “X+1”th viewpoint sub-pixel from the image signal source; and a voltage that is generated by a pixel voltage generating module by using the voltage written to the “X−1”th viewpoint sub-pixel and the voltage written to the “X+1”th viewpoint sub-pixel is written to the Xth-viewpoint sub-pixel. That is, a prescribed video is displayed also for the Xth-viewpoint sub-pixel that is not connected to the image signal source.

With the present invention, if there is about a half of video for the odd-numbered viewpoints on the display content side and the image signal source side, for example, the remaining video for the even-numbered viewpoints is generated by the pixel voltage generating module. Thus, it is possible to provide high-definition and fine stereoscopic image display. As a result, the number of outputs required for the image signal source can be reduced to about a half, for example.

Further, it is possible to employ a structure in which the pixel voltage generating module is provided in the Xth-viewpoint sub-pixel and generates an intermediate potential of the voltage written to the “X−1”th viewpoint sub-pixel and the voltage written to the “X+1”th viewpoint sub-pixel.

In addition to the effect described above, such structure makes it possible to form the pixel voltage generating module as a simple structure

Further, it is also possible to employ a structure which includes: a switching module which switches an intermediate potential generation mode which writes an intermediate potential to the Xth-viewpoint sub-pixel by the pixel voltage generating module and a 2D mode which takes a signal line selected among the signal lines connected to the image signal source within the N-pieces of viewpoints as the signal line connected to a Cth-viewpoint sub-pixel (C is a natural number satisfying 1≦C≦N) and writes a Cth-viewpoint sub-pixel voltage to all the viewpoint sub-pixels; and a mode switching signal generating module which generates a mode switching signal to be inputted to the switching module.

Thereby, in a case of stereoscopic image data with large parallax values where it is expected that a fine image quality cannot be acquired with the increase in the number of viewpoint by the intermediate potential, the stereoscopic video data can be converted into 2D video to be displayed.

Furthermore, it is also possible to include: a switching module which switches an intermediate potential generation mode which writes an intermediate potential to the Xth-viewpoint sub-pixel by the pixel voltage generating module and a neighbor copy mode which writes a voltage same as the voltage written to the “X−1”th viewpoint sub-pixel or the voltage written to the “X+1”th viewpoint sub-pixel to the Xth-viewpoint sub-pixel; and a mode switching signal generating module which generates a mode switching signal to be inputted to the switching module.

Thereby, in a case of stereoscopic image data with large parallax values between viewpoint images where it is expected that a fine image quality cannot be acquired with the increase in the number of viewpoint by the intermediate potential, it is possible to switch to display while keeping the number of viewpoints of the stereoscopic video data. This makes it possible to keep the fine stereoscopic image display, while the number of viewpoints is decreased.

According to the present invention, the multi-viewpoint image generating processing is performed in the pixel matrix within the stereoscopic image display device or between the image signal source and the pixel matrix. Thus, it is possible to provide the stereoscopic image display device for displaying multi-viewpoint images without giving load on the image signal source within the stereoscopic image display device. Further, the present invention can exhibits the effect in dealing with the increase in the number of viewpoints of the stereoscopic image display device, decrease in the video making system cost, and readiness of content creation.

Further, in a case of employing the structure where the pixel potential generating module is provided to the Xth-viewpoint sub-pixel for generating the intermediate potential of the voltage written to the “X−1”th viewpoint sub-pixel and the voltage written to the “X+1”th viewpoint sub-pixel, it is possible to provide the stereoscopic image display device capable of displaying multi-viewpoint images of a large number of viewpoints even when the number of output lines for transmitting the pixel voltage information of the multi-viewpoint images to the pixel matrix from the image signal source within the stereoscopic image display devices is small. That is, it is possible to provide a fine multi-viewpoint stereoscopic image display device even with the use of an image signal source with a small number of outputs widely used for 2D, for example, without using an exclusive-use image signal source of a large number of outputs or a large number of image signal sources. Therefore, the cost for members can be reduced.

Further, in a case of employing the structure which includes: the switching module which switches the intermediate potential generation mode which writes an intermediate potential to the Xth-viewpoint sub-pixel by the pixel voltage generating module and the 2D mode which takes a signal line selected among the signal lines connected to the image signal source within the N-pieces of viewpoints as the signal line connected to the Cth-viewpoint sub-pixel (C is a natural number satisfying 1≦C≦N) and writes the Cth-viewpoint sub-pixel voltage to all the viewpoint sub-pixels; and the mode switching signal generating module which generates a mode switching signal, it is possible to avoid showing a bad quality stereoscopic video to the observer in advance. It is because the display can be switched to 2D display in a case of a stereoscopic video where the parallax value between the viewpoint images is large and the image quality is deteriorated with the increase in the number of viewpoints by using the intermediate potential.

When such structure is employed, the observer can switch 3D display and 2D display spontaneously.

Furthermore, in a case of employing the structure which includes: a switching module which switches an intermediate potential generation mode which writes an intermediate potential to the Xth-viewpoint sub-pixel by the pixel voltage generating module and a neighbor copy mode which writes a voltage same as the voltage written to the “X−1”th viewpoint sub-pixel or the voltage written to the “X+1”th viewpoint sub-pixel to the Xth-viewpoint sub-pixel; and a mode switching signal generating module which generates a mode switching signal, it is also possible to avoid showing a bad quality stereoscopic video to the observer in advance. It is because the display can be switched to the display where the number of viewpoints is not increased in a case of a stereoscopic video where the parallax value between the viewpoint images is large and the image quality is deteriorated with the increase in the number of viewpoints by using the intermediate potential.

In the stereoscopic image display devices of Patent Documents 1 and 2, the multi-viewpoint image generating processing is performed by the image signal source which transmits the pixel voltage information of the multi-viewpoint image to the pixel matrix within the stereoscopic image display device. In the meantime, with the present invention, the multi-viewpoint image generating processing can be performed by the pixel matrix which receives the pixel voltage information. Thus, it is possible to provide the effect such as decreasing the scale of the image signal source as described above.

Further, with Patent Documents 1 and 2, a new viewpoint image is generated by performing image conversion processing (adding/subtracting processing of luminance differential image, image shift processing) from an image of 1-viewpoint within a plural-viewpoint image. In the meantime, with the present invention, it is possible to generate a new viewpoint image by performing image conversion processing from images of 2-viewpoints.
Further, the present invention can be applied not only to the stereoscopic image display device but also to a flat image display device. Therefore, it is possible to provide an effect of being able to provide a flat image display device which can improve the horizontal resolution of the display panel by generating a new image.

### BRIEF DESCRIPTION OF THE DRAWINGS

FIGS. 1A and 1B show a stereoscopic image display device according to a first exemplary embodiment, in which FIG. 1A is a plan view showing the entire stereoscopic image display device and FIG. 1B is a block diagram showing one pixel taken out from the stereoscopic image display device;

FIG. 2 is a circuit diagram showing a pixel voltage generating module according to the first exemplary embodiment;

FIG. 3 is a circuit diagram showing another pixel voltage generating module according to the first exemplary embodiment;

FIG. 4 is a circuit diagram showing a sub-pixel circuit according to a second exemplary embodiment;

FIG. 5 is a circuit diagram showing the sub-pixel circuit according to a second exemplary embodiment;

FIG. 6 is a timing chart of the second exemplary embodiment;

FIG. 7 is a circuit diagram showing an Xth-viewpoint sub-pixel circuit according to a third exemplary embodiment;

FIG. 8 is a circuit diagram showing an Xth-viewpoint sub-pixel circuit according to a fourth exemplary embodiment;

FIGS. 9A and 9B show block diagrams of a stereoscopic image display device according to a fifth exemplary embodiment, in which FIG. 9A shows the state of an intermediate voltage generation mode and FIG. 9B shows the state of 2D mode;

FIG. 10 is a block diagram showing a 2D making module according to the fifth exemplary embodiment;

FIG. 11 is a block diagram showing the 2D making module according to the fifth exemplary embodiment;

FIGS. 12A and 12B show block diagrams of a stereoscopic image display device according to a sixth exemplary embodiment, in which FIG. 12A shows the state of an intermediate potential generation mode and FIG. 12B shows the state of a neighbor copy mode;

FIGS. 13A-13C show a circuit diagram of a sub-pixel circuit according to the sixth exemplary embodiment and timing charts of the intermediate potential generation mode and the neighbor copy mode, in which FIG. 13A shows the circuit diagram, FIG. 13B shows the timing chart of the intermediate potential generation mode, and FIG. 13C shows the timing chart of the neighbor copy mode;

FIG. 14 is a block diagram showing a stereoscopic image display device according to a seventh exemplary embodiment;

FIG. 15 is a chart showing the relation regarding parallax values between the viewpoint images and the subjective evaluation of the observer of stereoscopic images;

FIG. 16 is a block diagram showing a stereoscopic image display device according to an eighth exemplary embodiment;

FIG. 17 is a plan view showing Example of the stereoscopic image display device;

FIG. 18 is a plan view showing 9-viewpoint pixel according to Example; and

FIG. 19 is a chart showing a layout example of a sub-pixel circuit according to Example.

### DETAILED DESCRIPTION OF THE PREFERRED EMBODIMENTS

Next, exemplary embodiments of the present invention will be described in details by referring to the accompanying drawings.

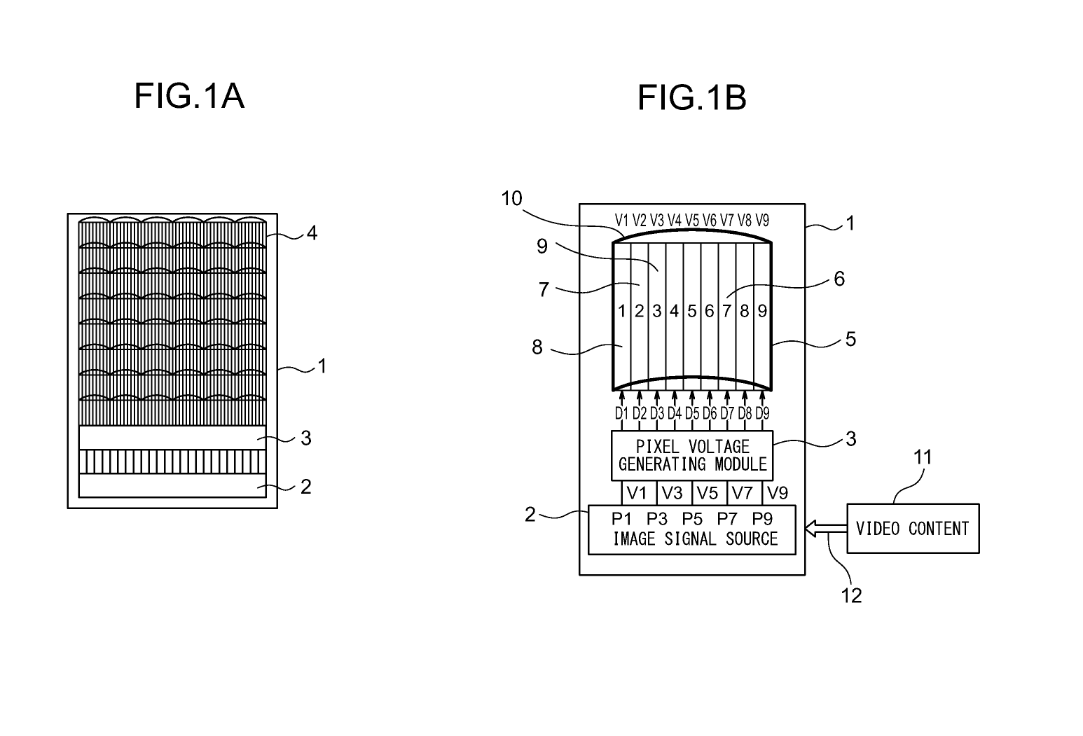

As shown in FIG. 1A, a stereoscopic image display device 1 according to the present invention is constituted with an image signal source 2, a pixel voltage generating module 3, and a pixel matrix 4 in which three or more pixels (referred to as 3D pixels) 5 are disposed.

FIG. 1B is a diagram which shows the connecting relation between the pixel voltage generating module 3 and the image signal source 2 by taking out one pixel out of a plurality of N-viewpoint 3D pixels 5 which constitute the pixel matrix 4 in order to provide a more detailed explanation. The 3D pixel 5 is constituted with sub-pixels 6 of N-viewpoints which correspond to the N-pieces of viewpoints expressed by a natural number N satisfying N≧3. In FIGS. 1A and 1B, shown is a case of 9-viewpoints (N=9).
Further, an optical separating module 10 for separating the sub-pixel 6 observed depending on the viewpoint position of the observer, e.g., a lens, is also included in the 3D pixel 5.
The sub-pixel 6 is a pixel such as liquid crystal, for example, which includes a liquid crystal pixel capacitance, a storage capacitance if necessary, and an electronic switch that is a pixel switch which links the capacitance to a signal line.
A pixel voltage corresponding to the image signal outputted from the image signal source 2 is written to the 3D pixel 5 by the electrical connection of the pixel switch.
Further, the pixel voltage outputted from the image signal source 2 is generated based on a plural-viewpoint image 12 outputted from a video content 11.
Note, however, that an Xth-viewpoint sub-pixel 7 (X is a natural number that is 2 or larger and N−1 or smaller) is not connected to the image signal source 2 directly and the pixel voltage of the image signal source 2 is not written to the Xth-viewpoint sub-pixel 7 directly. The feature of this exemplary embodiment is that the image signal source 2 writes and holds the voltage generated by the pixel voltage generating module 3 by using the voltages written to an “X−1”th viewpoint sub-pixel 8 that is one stage before the Xth-viewpoint sub-pixel and an “X+1”th viewpoint sub-pixel 9 that is one stage after the Xth-viewpoint sub-pixel to the Xth-viewpoint sub-pixel 7.
A voltage Vx generated by the pixel voltage generating module 3 is generated from a pixel voltage Va written to the “X−1”th viewpoint sub-pixel 8 and a pixel voltage Vb written to the “X+1”th viewpoint sub-pixel 9. As Vx, a voltage between Va and Vb, e.g., “(Va+Vb)/2” that is the intermediate potential, is preferable.

FIG. 1B shows a case where: the 1st, 3rd, 5th, 7th, 9th-viewpoint sub-pixels are connected to outputs V1, V3, V5, V7, V9 from terminals P1, P3, P5, P7, P9 of the image signal source 2 via corresponding signal lines D1, D3, D5, D7, D9, and pixel voltages are written thereto by the image signal source 2; and the 2nd, 4th, 6th, 8th-viewpoint sub-pixels corresponding to the Xth-viewpoint sub-pixel are connected, respectively, to signal lines D2, D4, D6, D8 of the pixel voltage generating module 3, and output voltages generated by the pixel voltage generating module 3 are written and held thereto. The 2nd-viewpoint sub-pixel is the Xth-viewpoint sub-pixel located at the intermediate position when the 1st-viewpoint sub-pixel, the 2nd-viewpoint sub-pixel, and the 3rd-viewpoint sub-pixel are selected as a set of three consecutive sub-pixels. The 4th-viewpoint sub-pixel is the Xth-viewpoint sub-pixel located at the intermediate position when the 3rd-viewpoint sub-pixel, the 4th-viewpoint sub-pixel, and the 5th-viewpoint sub-pixel are selected as a set of three consecutive sub-pixels. The 6th-viewpoint sub-pixel is the Xth-viewpoint sub-pixel located at the intermediate position when the 5th-viewpoint sub-pixel, the 6th-viewpoint sub-pixel, and the 7th-viewpoint sub-pixel are selected as a set of three consecutive sub-pixels. The 8th-viewpoint sub-pixel is the Xth-viewpoint sub-pixel located at the intermediate position when the 7th-viewpoint sub-pixel, the 8th-viewpoint sub-pixel, and the 9th-viewpoint sub-pixel are selected as a set of three consecutive sub-pixels.

While “X” is considered as even number in FIGS. 1A and 1B and the voltages are written to all the even-numbered sub-pixels by the pixel voltage generating module 3, the present invention is not limited only to that case.
For example, it is also possible to employ a structure in which: V1, V3, V4, V5, V6, V7, and V9 are prepared as the outputs of the image signal source 2; and the image signal source 2 writes the voltage to the 4th-viewpoint sub-pixel and the 6th-viewpoint sub-pixel among the even-numbered viewpoint sub-pixels while the pixel voltage generating module 3 writes the voltage only to the 2nd-viewpoint sub-pixel and the 8th-viewpoint sub-pixel. In that case, the 2nd-viewpoint sub-pixel is the Xth-viewpoint sub-pixel located at the intermediate position when the 1 st-viewpoint sub-pixel, the 2nd-viewpoint sub-pixel, and the 3rd-viewpoint sub-pixel are selected as a set of three consecutive sub-pixels, and the 8th-viewpoint sub-pixel is the Xth-viewpoint sub-pixel located at the intermediate position when the 7th-viewpoint sub-pixel, the 8th-viewpoint sub-pixel, and the 9th-viewpoint sub-pixel are selected as a set of three consecutive sub-pixels.
Further, for example, it is also possible to employ a structure in which: V1, V2, V4, V5, V6, V8, and V9 are prepared as the outputs of the image signal source 2; and the image signal source 2 writes the voltage to the 1st, 2nd, 4th, 5th, 6th, 8th, and 9th-viewpoint sub-pixels while the pixel voltage generating module 3 writes the voltage only to the 3rd-viewpoint sub-pixel and the 7th-viewpoint sub-pixel, i.e., X is odd number. In that case, the 3rd-viewpoint sub-pixel is the Xth-viewpoint sub-pixel located at the intermediate position when the 2nd-viewpoint sub-pixel, the 3rd-viewpoint sub-pixel, and the 4th-viewpoint sub-pixel are selected as a set of three consecutive sub-pixels, and the 7th-viewpoint sub-pixel is the Xth-viewpoint sub-pixel located at the intermediate position when the 6th-viewpoint sub-pixel, the 7th-viewpoint sub-pixel, and the 8th-viewpoint sub-pixel are selected as a set of three consecutive sub-pixels.

That is, it is possible to select at least one set of three consecutive sub-pixels among N-pieces of sub-pixels in such a manner that two sub-pixels or more of each set do not overlap, and to take the sub-pixel located in the midpoint of the set of the sub-pixels as the Xth-viewpoint sub-pixel 7.

For example, in a case where two sets of the sub-pixels are selected, it is allowed to: select a set of the 1st, 2nd, 3rd-viewpoint sub-pixels and a set of 3rd, 4th, 5th-viewpoint sub-pixels; write the voltage to the 1st and 3rd-viewpoint sub-pixels in the set of the 1st, 2nd, 3rd-viewpoint pixels from the image signal source 2 and write the voltage to the 2nd-viewpoint sub-pixel from the pixel voltage generating module 3; and write the voltage to the 3rd and 5th-viewpoint sub-pixels in the set of the 3rd, 4th, 5th-viewpoint pixels from the image signal source 2 and write the voltage to the 4th-viewpoint sub-pixel from the pixel voltage generating module 3. In that case, only one sub-pixel between each of the sets, i.e., the 3rd-viewpoint sub-pixel in this case, is overlapped.
In the meantime, it is not allowed to: for example, select a set of the 1st, 2nd, 3rd-viewpoint sub-pixels and a set of 2th, 3rd, 4th-viewpoint sub-pixels so that the two sub-pixels, e.g., the 2nd and 3rd-viewpoint sub-pixels, overlap; write the voltage to the 1st and 3rd-viewpoint sub-pixels in the set of the 1st, 2nd, 3rd-viewpoint pixels from the image signal source 2 and write the voltage to the 2nd-viewpoint sub-pixel from the pixel voltage generating module 3; and write the voltage to the 2nd and 4th-viewpoint sub-pixels in the set of the 2nd, 3rd, 4th-viewpoint pixels from the image signal source 2 and write the voltage to the 3rd-viewpoint sub-pixel from the pixel voltage generating module 3. The reason for that is as follows. That is, it is so defined at the point of selecting the set of the 1st, 2nd, 3rd-viewpoint sub-pixels to write the voltage to the 2nd-viewpoint sub-pixel from the pixel voltage generating module 3 and to write the voltage to the 3rd-viewpoint sub-pixel from the image signal source 2. However, when the set of the 2nd, 3rd, 4th-viewpoint sub-pixels are selected anew, there is such contradiction generated that the voltage is written to the 2nd-viewpoint sub-pixel from the image signal source 2 and the voltage is written to the 3rd-viewpoint sub-pixel from the pixel voltage generating module 3.
Such contraction can be prevented by selecting at least one set of three consecutive sub-pixels among N-pieces of sub-pixels in such a manner that two sub-pixels or more of each set do not overlap, and taking the sub-pixel located in the midpoint of the set of the sub-pixels as the Xth-viewpoint sub-pixel 7. That is, as long as such condition applies, there is no limit set in the number of sets of the three consecutive sub-pixels to be selected.

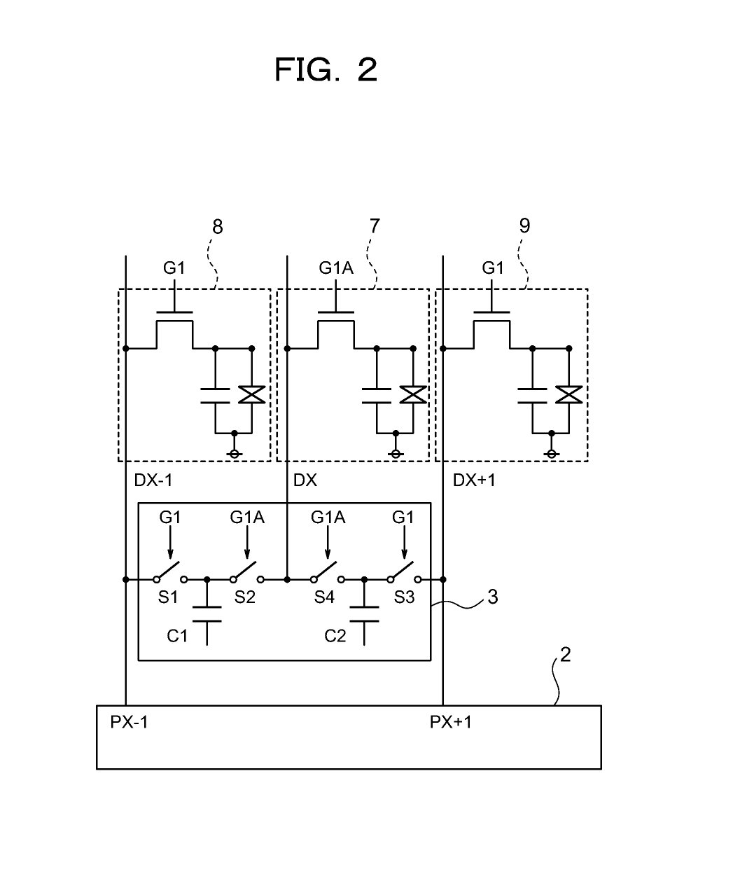

FIG. 2 shows a structural example of the pixel voltage generating module 3 which outputs the intermediate potential. Assuming that a signal line for transmitting the voltage to be written to the “X−1”th viewpoint sub-pixel 8 is DX−1 and a signal line for transmitting the voltage to be written to the “X+1”th viewpoint sub-pixel 9 is DX+1, the pixel voltage generating module 3 is constituted with: a first switch S1 which links the signal line DX−1 corresponding to the “X−1”th viewpoint sub-pixel 8 to a holding capacitance C1 that is a first pixel capacitance of the Xth-viewpoint sub-pixel 7; a second switch S3 which links the signal line DX+1 corresponding to the “X+1”th viewpoint sub-pixel 9 to a holding capacitance C2 that is a second pixel capacitance of the Xth-viewpoint sub-pixel 7; and a switch S2 which links the holding capacitance C1 as the first pixel capacitance of the Xth-viewpoint sub-pixel 7 to an output DX of the pixel voltage generating module 3 and a switch S4 which links the holding capacitance as the second pixel capacitance of the Xth-viewpoint sub-pixel 7 to the output DX of the pixel voltage generating module 3, i.e., switches S2, S4 functioning as a third switch for balancing the potentials of the first and second holding capacitances C1 and C2 by linking the first pixel capacitance C1 to the second pixel capacitance C2.

Further, the voltage Va to be written to the “X−1”th viewpoint sub-pixel 8 is outputted from a terminal PX−1 of the image signal source 2, and the voltage Vb to be written to the “X+1”th viewpoint sub-pixel 9 is outputted from a terminal PX+1. When the voltage is written to each of the sub-pixels 8 and 9 by a signal G1, the first and second switches S1, S3 are closed simultaneously by the signal G1 and the voltages Va, Vb are held to the holding capacitances C1, C2, respectively. At this time, the third switches S2 and S4 are shut down simultaneously by a signal G1A whish does not become active simultaneously with the signal G1.
Then, after opening the switches S1, S3 by setting off the signal G1 and closing the switches S2, S4 by the signal G1A, the voltage Vx from the output Dx becomes a balanced voltage between Va and Vb as a result of distributing the electric charge generated between the capacitances. This can be expressed simply as Vx=(C1*Va+C2*Vb)/(C1+C2). In a case where C1=C2, it can be expressed as Vx=(Va+Vb)/2, which is an intermediate potential of Va and Vb. The voltage Vx of this output DX is written to the Xth-viewpoint sub-pixel 7 by closing the switches S2, S4 which are operated by the signal GlA.

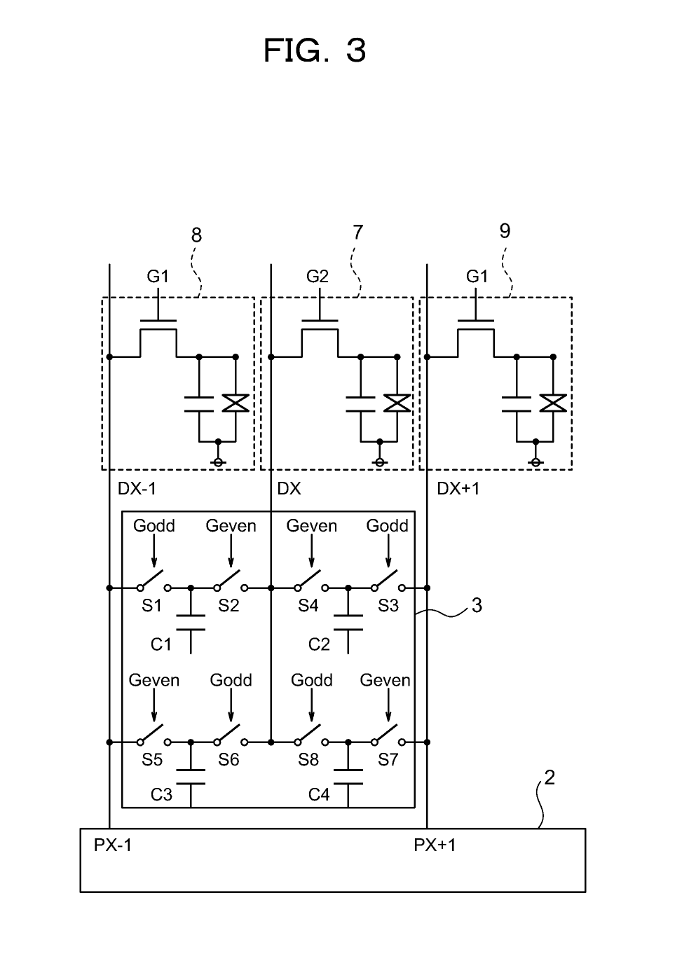

FIG. 3 shows a structural example of another pixel voltage generating module 3. The pixel voltage generating module 3 is constituted with: a switch S1 which links the signal line DX−1 for transmitting the voltage to be written to the “X−1”th viewpoint sub-pixel 8 to a holding capacitance C1; a switch S2 which links the holding capacitance C1 to the output DX of the pixel voltage generating module 3; a switch S3 which links the signal line DX+1 for transmitting the voltage to be written to the “X+1”th viewpoint sub-pixel 9 to a holding capacitance C2; a switch S4 which links the holding capacitance C2 to the output DX of the pixel voltage generating module 3; a switch S5 which links the signal line DX−1 corresponding to the “X−1”th viewpoint sub-pixel 8 to a holding capacitance C3; a switch S6 which links the holding capacitance C3 to the output DX of the pixel voltage generating module 3; a switch S7 which links the signal line DX+1 for transmitting the voltage to be written to the “X+1”th viewpoint sub-pixel 9 to a holding capacitance C4; and a switch S8 which links the holding capacitance C4 to the output DX of the pixel voltage generating module 3.

A signal Godd for controlling electrical connection of the switches S1, S3, S6, and S8 is synchronized with the odd-numbered signals among the gate signals of the pixel array, and a signal Geven for controlling electrical connection of the switches S2, S4, S5, and S7 is synchronized with the even-numbered signals among the gate signals of the pixels. For example, when the first gate signal G1 that is an odd-numbered gate signal is active, the signal Godd is set active and the voltages of the signal line DX−1 and the signal line DX+1 are held to the holding capacitances C1, C2, respectively, via the switches S1, S3. At the same time, those voltages are written and held to the “X−1”th viewpoint sub-pixel 8 and the “X+1”th viewpoint sub-pixel 9.
Then, when a second gate signal G2 as an even-numbered gate signal is active, the signal Godd becomes inactive and the signal Geven becomes active. Thereby, the holding capacitances C1 and C2 are simultaneously connected to the signal line DX, so that the intermediate voltage of the voltages written earlier to the “X−1”th viewpoint sub-pixel 8 and the “X+1”th viewpoint sub-pixel 9 is written and held to the Xth-viewpoint sub-pixel 7, while the voltages of the signal line DX−1 and the signal line DX+1 are held to the holding capacitances C3, C4, respectively, via the switches S5, S7. Those voltages are written to the “X−1”th viewpoint sub-pixel and the “X+1”th viewpoint sub-pixel, not shown, controlled by the gate signal G2. When a third gate signal G3 that is a next odd-numbered gate signal is active, the intermediate voltage thereof is written and held to the Xth-viewpoint sub-pixel, not shown, controlled by the gate signal G3. That is, the feature of the pixel voltage generating module 3 in FIG. 3 is to perform reciprocal actions between two actions regarding the two sets of holding capacitances C1, C2, and the holding capacitances C3, C4, i.e., an action of holding the voltages of the signal line DX−1 and the signal line DX+1 and an action of writing the intermediate potential to the signal line DX.

Other than capacitance voltage division shown in FIG. 2, resistance voltage division may be used for the pixel voltage generating module 3. For example, the multi-value voltage source circuits disclosed in U.S. Pat. No. 2,701,710 and U.S. Pat. No. 2,833,564 may be utilized. That is, defining as n=2 with the multi-value voltage source circuits disclosed in FIG. 1 of U.S. Pat. No. 2,833,564, the output terminal 5, the output N1 of the voltage control module 2, and the output N3 of the voltage control module 3 are corresponded to the output DX of the pixel voltage module 3, the output PX−1 of the image signal source 2, and the output PX+1 of the image signal source 2, respectively. From the output terminal 5, the voltage acquired by dividing the output N1 of the voltage control module 2 and the output N2 of the voltage control module 3 by the resistances Rs1 and Rs2 is outputted.

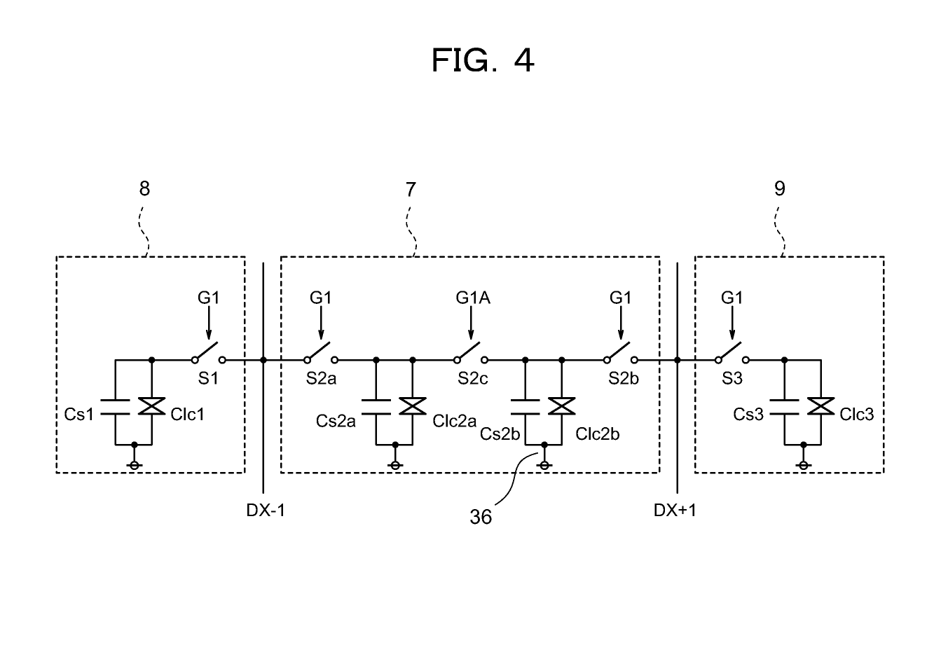

Next, a second exemplary embodiment will be described by referring to FIG. 4. The feature of this exemplary embodiment is that the above-described pixel voltage generating module 3 is provided in the Xth-viewpoint sub-pixel 7.

Among the N-pieces of sub-pixels 6 constituting the N-viewpoint 3D pixel 5, the “X−1”th viewpoint sub-pixel 8, the Xth-viewpoint sub-pixel 7, and the “X+1”th viewpoint sub-pixel 9 are extracted and shown in FIG. 4.
The “X−1”th viewpoint sub-pixel 8 of the exemplary embodiment is constituted with: a pixel capacitance Clc1, a storage capacitance Cs1, and a switch S1 which links the signal line DX−1, the pixel capacitance Clc1, and the storage capacitance Cs1.
Further, the “X+1”th viewpoint sub-pixel 9 is constituted with: a pixel capacitance Clc3, a storage capacitance Cs3, and a switch S3 which links the signal line DX+1, the pixel capacitance Clc3, and the storage capacitance Cs3.

Further, the Xth-viewpoint sub-pixel 7 is constituted with: a pixel capacitance Clc2a which is the first pixel capacitance of the Xth-viewpoint sub-pixel 7; a pixel capacitance Clc2b which is the second pixel capacitance of the Xth-viewpoint sub-pixel 7; a storage capacitance Cs2a, a storage capacitance Cs2b; a first switch S2a which links the signal line DX−1 corresponding to the “X−1”th viewpoint sub-pixel 8, the pixel capacitance Clc2a, and the storage capacitance Cs2a; a second switch S2b which links the signal line DX+1 corresponding to the “X+1”th viewpoint sub-pixel 9, the pixel capacitance Clc2b, and the storage capacitance Cs2b; and a third switch S2c which links the pixel capacitance Clc2a, the storage capacitance Cs2a, the pixel capacitance Clc2b, and the storage capacitance Cs2b.

Actions thereof will be described hereinafter.

When writing the pixel voltage Va to the “X−1”th viewpoint sub-pixel 8 and writing the pixel voltage Vb to the “X+1”th viewpoint sub-pixel 9, respectively, i.e., when setting on the switch S1 and the switch S3 by the signal G1, the first switch S2a and the second switch S2b of the Xth-viewpoint sub-pixel 7 are closed to charge the potential Va of the signal line DX−1 to the pixel capacitance Clc2a, the storage capacitance Cs2a and to charge the potential Vb of the signal line DX+1 to the pixel capacitance Clc2b, the storage capacitance Cs2b.
Then, when cutting the “X−1”th viewpoint sub-pixel 8 and the “X+1”th viewpoint sub-pixel 9 from the respective signal lines DX−1 and DX+1, i.e., when the signal G1 is set off, similarly the first and the second switches S2a, S2b are opened and the third switch S2c is closed by the signal G1A that does not become active simultaneously with the signal G1. Thereby, the electric charges are distributed between the electric charges charged to the pixel capacitance Clc2a, the storage capacitance Cs2a and the pixel capacitance Clc2b, the storage capacitance Cs2b. Thus, the potentials of the both are balanced at Vx between Va and Vb. That is, the pixel voltage held to the Xth-viewpoint sub-pixel 7, i.e., the voltage generated by the pixel voltage generating module 3, is the voltage Vx held to the pixel capacitances Clc2a, Clc2b and the storage capacitances Cs2a, Cs2b.
Vx can be simply expressed as Vx=((Clc2a+Cs2a)*Va+(Clc2b+Cs2b)*Vb)/(Clc2a+Cs2a+Clc2b+Cs2b). In a case where Clc2a+Cs2a=Clc2b+Cs2b, Vx can be expressed as Vx=(Va+Vb)/2, which is the intermediate potential of Va and Vb. Further, through giving a difference between Clc2a+Cs2a and Clc2b+Cs2b by changing the size or area of the sub-pixels, for example, it is possible to perform adjustment to make the potential Vx be closer to Va or to Vb.
The pixel capacitances Clc2a, Clc2b and the storage capacitances Cs2a, Cs2b of the Xth-viewpoint sub-pixel 7 are used for displaying images and also function as the holding capacitances constituting the pixel voltage generating module 3, i.e., the first pixel capacitance C1 and the second pixel capacitance C2 shown in FIG. 2. That is, the advantage of the second exemplary embodiment is that other holding capacitances C1 and C2 become unnecessary through mounting the pixel voltage generating module 3 into the Xth-viewpoint sub-pixel 7.
On calculation, a larger capacitance value compared to the parasitic capacitance of the signal lines DX−1 and DX+1 distributed to the pixel matrix 4 is required for the holding capacitances C1 and C2 of the first exemplary embodiment. However, in the case of the second exemplary embodiment where the pixel voltage generating module 3 is mounted into the sub-pixel, the capacitance is also used as the pixel capacitance for display. Thus, it is sufficient for the capacitance value to be equivalent to the normal capacitance of the “X−1”th sub-pixel and the “X+1”th sub-pixel or about a half value thereof. It is because the pixel capacitance of the Xth-viewpoint sub-pixel 7 is the sum of the pixel capacitance Clc2a and the pixel capacitance Clc2b.

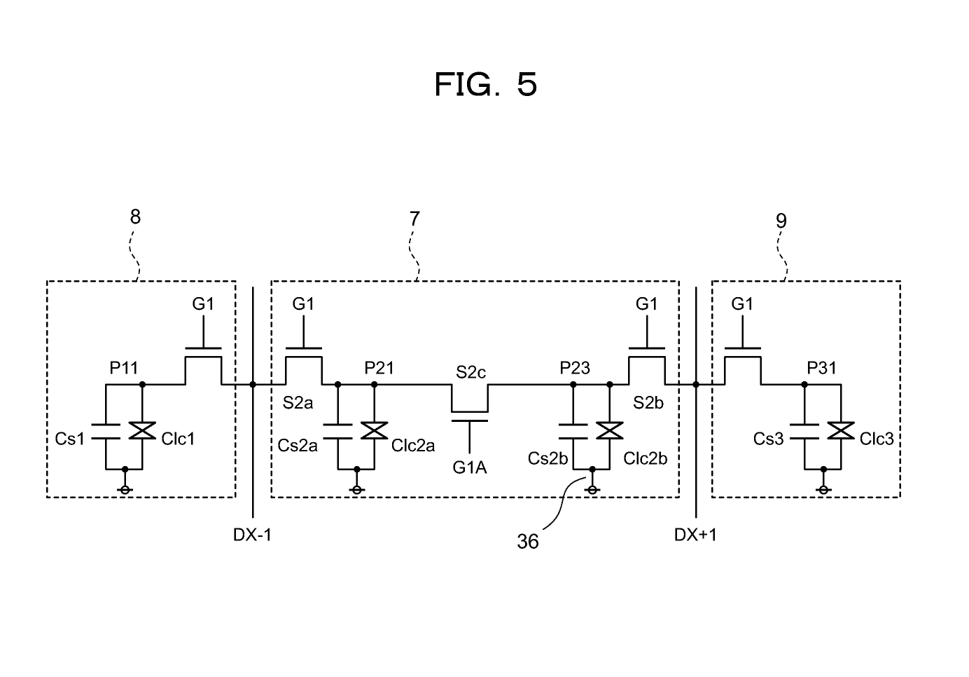

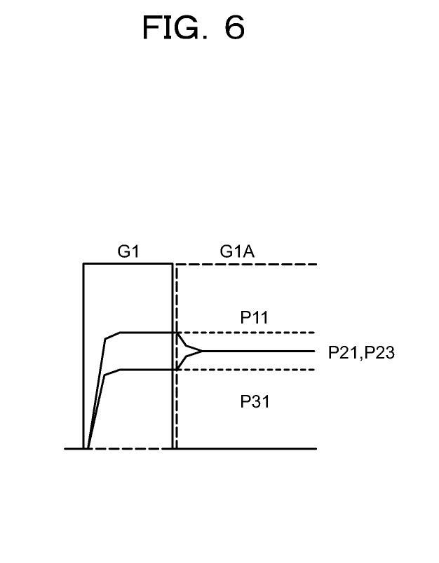

FIG. 5 shows a case where the electronic switches (pixel switches S1, S3, and switches S2a, S2b, S2c) of the exemplary embodiment shown in FIG. 4 are the N-type thin film transistors. Further, FIG. 6 shows a timing chart when the circuit is in action.

In the timing chart of FIG. 6, shown is an example of changes in the potentials of the gate signals G1, GlA, and the nodes P11, P21, P23, P31 of FIG. 5.
The gate signal G1 of the first and second switches S2a, S2b of the Xth-viewpoint sub-pixel 7 may simply need to be in common to the gate signal used when performing switching in the “X−1”th viewpoint sub-pixel 8 and writing the pixel voltage Vb to the “X+1”th viewpoint sub-pixel 9 and may be one of the scan signals that scan the pixel matrix 4 sequentially. In the meantime, the gate signal of the third switch S2c need to be the signal G1A which does not become active simultaneously with G1. For example, it is possible to use non-overlap logic inversion signal of the gate signal G1 or a sequential scan signal different from the gate signal G1. Especially, when a scan line signal G2 of a lower row of neighboring wiring is used, it is not necessary to add any special scan signal line to the pixel matrix 4 for achieving the present invention so that the aperture of the pixel can be widened.
Further, as another method, by replacing only the switch S2c with a P-type transistor that is a reversed polarity from that of the switches S2a, S2b, it is possible to scan one line only with the common gate signal G1. That is, it is not necessary to add a wiring to the pixel matrix 4.

A third exemplary embodiment of the present invention will be described. The difference between the third exemplary embodiment and the second exemplary embodiment is that the pixel voltage written to the Xth-viewpoint sub-pixel 7 is the intermediate voltage of the pixel voltages written to the “X−1”th viewpoint sub-pixel 8 and the “X+1”th viewpoint sub-pixel 9 and that the polarity is inverted.

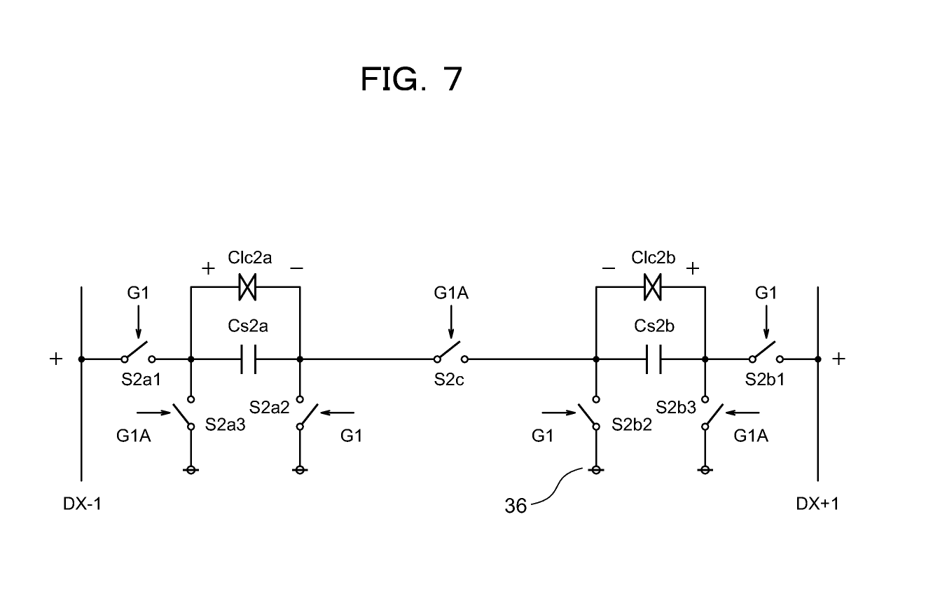

FIG. 7 is a chart showing the Xth-viewpoint sub-pixel according to the third exemplary embodiment.
The Xth-viewpoint sub-pixel 7 shown in FIG. 7 is constituted with: pixel capacitances Clc2a, Clc2b; storage capacitances Cs2a, Cs2b; a first switch S2a1 which links the signal line DX−1 for transmitting the voltage to be written to the “X−1”th viewpoint sub-pixel to the first electrode of the pixel capacitance Clc2a and the storage capacitance Cs2a as the first pixel capacitance of the Xth viewpoint sub-pixel 7 (left side of FIG. 7); a second switch S2a3 which links the first electrode of the pixel capacitance Clc2a and the storage capacitance Cs2a as the first pixel capacitance to a common electrode 36; a third switch S2a2 which links the second electrode of the pixel capacitance Clc2a and the storage capacitance Cs2a as the first pixel capacitance (right side of FIG. 7) to the common electrode 36; a fourth switch S2b1 which links the signal line DX+1 for transmitting the voltage to be written to the “X+1”th viewpoint sub-pixel to the third electrode of the pixel capacitance Clc2b and the storage capacitance Cs2b as the second pixel capacitance of the Xth viewpoint sub-pixel 7 (right side of FIG. 7); a fifth switch S2b3 which links the third electrode of the pixel capacitance Clc2b the and the storage capacitance Cs2b as the second pixel capacitance to the common electrode 36; a sixth switch S2b2 which links the fourth electrode of the pixel capacitance Clc2b and the storage capacitance Cs2b as the second pixel capacitance (left side of FIG. 7) to the common electrode 36; and a seventh switch S2c which links the second electrode of the pixel capacitance Clc2a and the storage capacitance Cs2a as the first pixel capacitance to the fourth electrode of the pixel capacitance Clc2b and the storage capacitance Cs2b as the second pixel capacitance to balance the potentials of the first pixel capacitance and the second pixel capacitance.

The actions thereof will be described hereinafter.

When writing the positive-polarity pixel voltage Va to the “X−1”th viewpoint sub-pixel 8 and writing the positive-polarity pixel voltage Vb to the “X+1”th viewpoint sub-pixel 9, respectively, by setting on the gate signal G1, the first switch S2a1 of the Xth-viewpoint sub-pixel 7 is closed to connect the positive-polarity potential Va to the first electrode of the pixel capacitance Clc2a and the storage capacitance Cs2a as the first pixel capacitance. Further, the third switch S2a3 is closed to connect the second electrode of the pixel capacitance Clc2a and the storage capacitance Cs2a as the first pixel capacitance to the potential of the common electrode 36 to charge the pixel capacitance Clc2a and the storage capacitance Cs2a. That is, +Va in the polarity of FIG. 7 is held at the pixel capacitance Clc2a. Similarly, the fourth switch S2b1 is closed to connect the positive-polarity potential Vb to the third electrode of the pixel capacitance Clc2b and the storage capacitance Cs2b as the second pixel capacitance and, further, the sixth switch S2b2 is closed to connect the fourth electrode of the pixel capacitance Clc2b and the storage capacitance Cs2b as the second pixel capacitance to the potential of the common electrode 36 to charge the pixel capacitance Clc2b and the storage capacitance Cs2b. That is, +Vb in the polarity of FIG. 7 is held at the pixel capacitance Clc2b.
Then, when cutting the “X−1”th viewpoint sub-pixel 8 and the “X+1”th viewpoint sub-pixel 9 from the respective signal lines by setting off the signal G1, similarly the first, the third switches S2a1, S2a2 and the fourth, sixth switches S2b1, S2b2 are opened and the seventh, the second, and the fifth switches S2c, S2a3, S2b3 are closed by setting on the signal G1A. By the electrical connection of the second and the fifth switches S2a3 and S2b3, each of the potentials on one end of each of the capacitances, i.e., the potential on the first electrode side of the pixel capacitance Clc2a and the storage capacitance Cs2a as the first pixel capacitance and the potential on the third electrode side of the pixel capacitance Clc2b and the storage capacitance Cs2b as the second pixel capacitance change to the potential of the common electrode 36. However, the electric charges charged to each of the capacitances are held. Thus, the potentials on the other end of each of the capacitances, i.e., the potential on the second electrode side of the pixel capacitance Clc2a and the storage capacitance Cs2a as the first pixel capacitance and the potential on the fourth electrode side of the pixel capacitance Clc2b and the storage capacitance Cs2b as the second pixel capacitance become −Va and −Vb, respectively, which are the potentials whose polarity is inverted from the held voltages. Further, by the electrical connection of the seventh switch S2c, the electric charges are distributed between the pixel capacitance Clca2 and the storage capacitance Cs2a as the first pixel capacitance and the pixel capacitance Clc2b and the storage capacitance Cs2b as the second pixel capacitance, so that the potentials of the both are balanced as −Vx between −Va and −Vb. That is, the pixel voltage written to the Xth-viewpoint sub-pixel 7 becomes −Vx, which is the intermediate voltage, for example, between the voltage Va written to the neighboring “X−1”th viewpoint sub-pixel 8 and the voltage Vb written to the “X+1”th viewpoint sub-pixel 9 and the polarity thereof is inverted. The polarities of the voltages applied to the pixels are inverted between the neighboring sub-pixels, thereby contributing to improving the image quality.

A fourth exemplary embodiment will be described. The difference between the fourth exemplary embodiment and the second exemplary embodiment is that the pixel voltage written to the Xth-viewpoint sub-pixel 7 is the intermediate voltage of the absolute values of the pixel voltages written to the “X−1”th viewpoint sub-pixel 8 and the “X+1”th viewpoint sub-pixel 9 and that the polarity is the same as that of the pixel voltage written to the “X+1”th viewpoint sub-pixel.

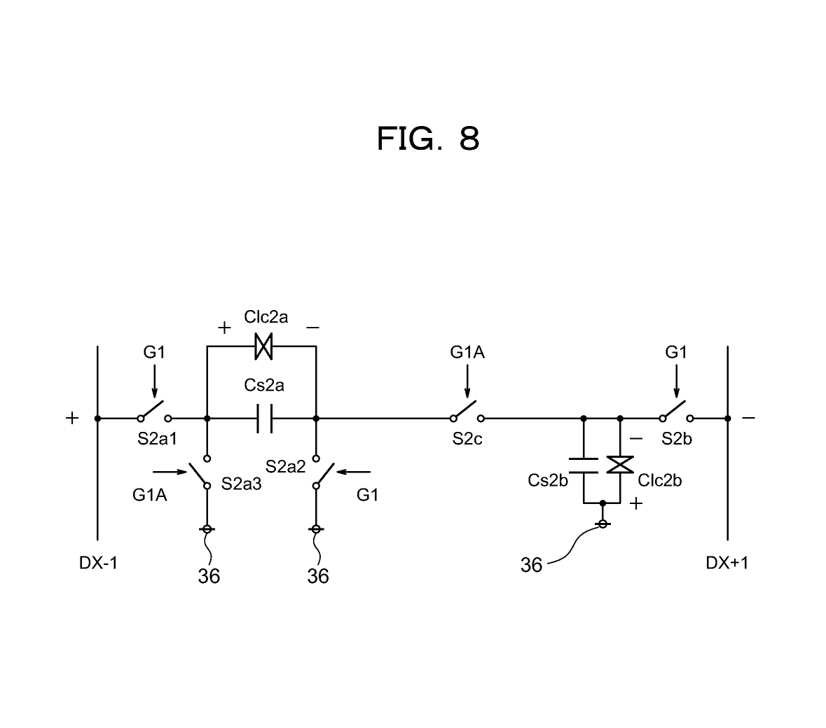

FIG. 8 is a chart showing the Xth-viewpoint sub-pixel according to the fourth exemplary embodiment.
The Xth-viewpoint sub-pixel 7 of FIG. 8 is constituted with: pixel capacitances Clc2a, Clc2b; storage capacitances Cs2a, Cs2b; a first switch S2a1 which links the signal line DX−1 for transmitting the voltage to be written to the “X−1”th viewpoint sub-pixel to the first electrode of the pixel capacitance Clc2a and the storage capacitance Cs2a as the first pixel capacitance of the Xth viewpoint sub-pixel 7 (left side of FIG. 8); a second switch S2a3 which links the first electrode of the pixel capacitance Clc2a and the storage capacitance Cs2a as the first pixel capacitance to a common electrode 36; a third switch S2a2 which links the second electrode of the pixel capacitance Clc2a and the storage capacitance Cs2a as the first pixel capacitance (right side of FIG. 8) to the common electrode 36; a fourth switch S2b1 which links the signal line DX+1 for transmitting the voltage to be written to the “X+1”th viewpoint sub-pixel to the third electrode of the pixel capacitance Clc2b and the storage capacitance Cs2b as the second pixel capacitance of the Xth viewpoint sub-pixel 7 (upper side of FIG. 8); and a fifth switch S2c which links the second electrode of the pixel capacitance Clc2a and the storage capacitance Cs2a as the first pixel capacitance to the third electrode of the pixel capacitance Clc2b and the storage capacitance Cs2b as the second pixel capacitance to balance the potentials of the first pixel capacitance and the second pixel capacitance.
Note that the fourth electrode of the capacitances Clc2b and Cs2b (lower side of FIG. 8) is connected to the common electrode 36. The circuit regarding the capacitances Clc2a and Cs2a is the same as that of the third exemplary embodiment, and the circuit regarding the capacitances Clc2b and Cs2b is the same as that of the second exemplary embodiment.

The actions thereof will be described hereinafter.

The positive-polarity pixel voltage Va is written to the “X−1”th viewpoint sub-pixel 8 by the gate signal G1 and, at the same time, the potential Va is written to the first electrode that is one end of the pixel capacitance Clc2a and the storage capacitance Cs2a as the first pixel capacitance. Thereafter, when the gate signal G1 is set off and the gate signal G1A is set on, the inverted potential −Va is charged to the second electrode that is the other end of the pixel capacitance Clc2a and the storage capacitance Cs2a as the first pixel capacitance. Further, when the negative-polarity pixel voltage −Vb is written to the “X+1”th viewpoint sub-pixel 9 by the gate signal G1, the negative-polarity pixel voltage −Vb is charged also to the third electrode that is one end of the pixel capacitance Clc2b and the storage capacitance Cs2b as the second pixel capacitance. Then, by closing the fifth switch S2c, the potential of the first pixel capacitance and the second pixel capacitance are balanced so that the pixel voltage written to the Xth-viewpoint sub-pixel 7 becomes −Vx that is between −Va and −Vb. The polarities of the voltages applied to the pixels between the neighboring sub-pixels changed as +, −, −, thereby achieving polarity inversion.
The difference between the fourth exemplary embodiment and the third exemplary embodiment is that the polarity of the pixel voltage to be transmitted is inverted between the signal line DX−1 and the signal line DX+1. On the display screen as a whole, if the image signal source 2 driving the signal lines outputs only the same-polarity voltages, there is deviation generated on the load of the direct current power source supplied to the image signal source 2. Thus, the signal line driving capacity is deteriorated. Further, when charging the pixel capacitance via the signal line, a charge current for accumulating the inverted-polarity electric charge is also flown to the pixel capacitance terminal on the common electrode 36 side. When the sub-pixels to which the polarities of the voltages to be written thereto are inverted exist close to each other, the polarities of the electric charges to be accumulated on the common electrode 36 side are inverted between those sub-pixels. Thus, a balanced state is achieved by the migration of the electric charges between the adjacent sub-pixels, so that the charge time can be shortened. That is, compared to the third exemplary embodiment, the signal line driving capacity of the image signal source 2 is not deteriorated and the charge time is shortened with the fourth exemplary embodiment.

Next, a fifth exemplary embodiment of the present invention will be described. A stereoscopic image display device disclosed in this exemplary embodiment includes a mode which changes multi-viewpoint stereoscopic image display to 2D display by writing a voltage to be written to a Cth-viewpoint sub-pixel (where 1≦C≦N), for example, in common to the 3D pixel 5 that is constituted with the sub-pixels 6 of N-viewpoints, in addition to an intermediate potential generation mode executed by the pixel voltage generating module shown in the first to the fourth exemplary embodiment, i.e., a mode which generates the intermediate potential Vx between the pixel voltage Va that is written to the “X−1”th viewpoint sub-pixel and the pixel voltage Vb that is written to the “X+1”th viewpoint sub-pixel and writes it to the Xth-viewpoint sub-pixel by balancing the potentials written to the first pixel capacitance and the second pixel capacitance. The stereoscopic image display device is provided with a module for switching to one of the modes and a module 20 which generates a signal for changing the mode.

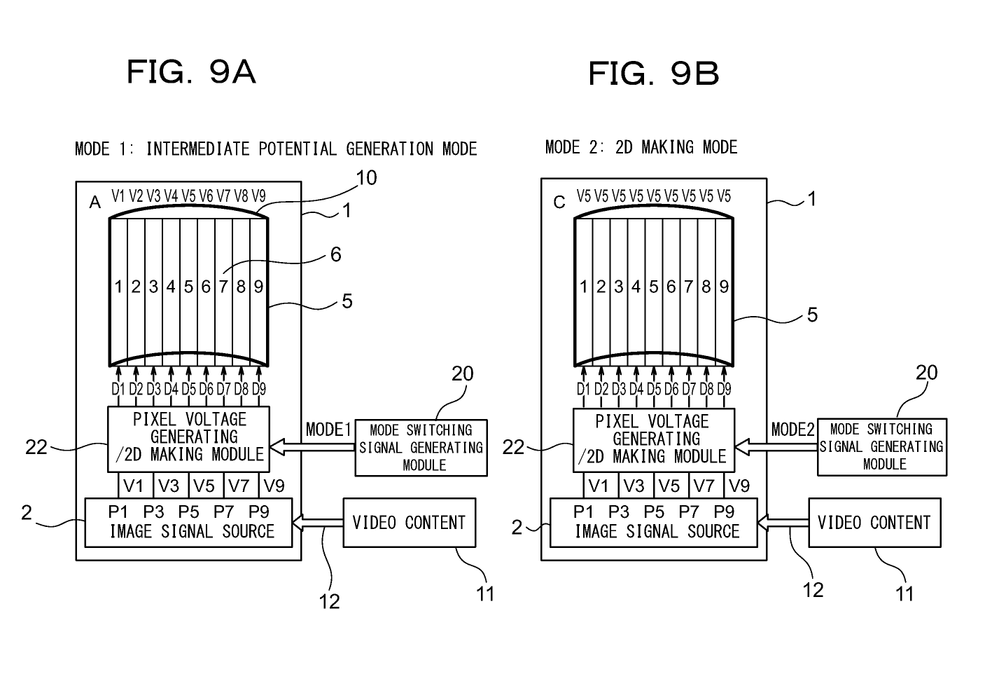

The stereoscopic image display device 1 shown in FIG. 9 is constituted with: a pixel voltage generating module/2D making module (switching module) 22 which is connected to the image signal sources 2; and the 3D pixels 5 each constituted with the sub-pixels 6 of N-viewpoints, which are connected to those. FIG. 9 shows a case where the number N of viewpoints is 9. The module to be operated is switched between the pixel voltage generating module and the 2D making module by the mode switching signal outputted from the mode signal generating module 20. In a case of the intermediate voltage generation mode that is Mode 1 shown in FIG. 9A, the pixel voltage generating module/2D making module 22 generates V2 (intermediate potential of V1 and V3), V4 (intermediate potential of V3 and V5), V6 (intermediate potential of V5 and V7), and V8 (intermediate potential of V7 and V9) by utilizing the pixel voltages V1, V3, V5, V7, and V9 outputted from the image signal source 2, and the voltages of V1 to V9 are written to the 1st to 9th-viewpoint sub-pixels, respectively.
Further, in a case of a 2D mode that is Mode 2 shown in FIG. 9B, V5 (in a case where C=5), for example, is selected by the pixel voltage generating module/2D making module 22 among the pixel voltages V1, V3, V5, V7, and V9 outputted from the image signal source 2 and the pixel voltage V5, i.e., the pixel voltage V5 of the 5th-viewpoint sub-pixel shown by a natural number closest to N/2 in a case where N=9, is written to all of the 1st to 9th-viewpoint sub-pixels.

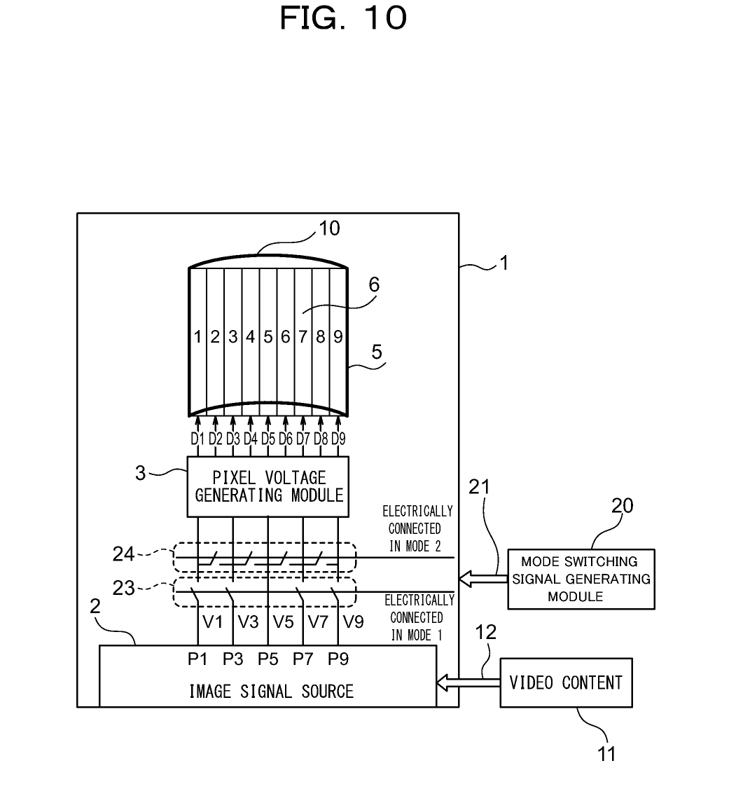

FIG. 10 shows an example of the 2D making module out of the pixel voltage generating module/2D making module 22. In FIG. 10, the pixel voltage generating module and the 2D making module are separately shown out of the pixel voltage generating module/2D making module shown in FIG. 9.

One output (V5 in FIG. 10) out of the outputs V1, V3, V5, V7, and V9 of the image signal source is connected to the signal line (signal line corresponding to the output V5 in the case of FIG. 10) in the 3D pixel 5 that is connected to a given Cth-viewpoint sub-pixel. A first switch group 23 is provided between the other outputs V1, V3, V7, V9 and the input lines to the pixel voltage generating module 3 corresponding to each of those outputs. The input lines to the pixel voltage generating module 3 are also connected to the corresponding signal lines of the 3D pixel 5 via the pixel voltage generating module 3. Electrical connection and shutdown of the first switch group 23 are selected by the mode signal. In a case of Mode 1, the first switch group 23 is electrically connected to connect the outputs V1, V3, V7, and V9 to the corresponding input lines of the pixel voltage generating module 3.
Further, a second switch group 24 for mutually connecting the outputs V1, V3, V5, V7, V9 to all the corresponding input lines to the pixel voltage generating module 3 to be electrically connected when Mode 2 is selected.
That is, in Mode 1 (intermediate voltage generation mode), the first switch group 23 is electrically connected and the second switch group 24 is shutdown to write the outputs V1, V3, V5, V7, V9 of the image signal source 2 to the 1st, 3rd, 5th, 7th, and 9th-viewpoint sub-pixels via the corresponding input lines to the pixel voltage generating module 3 and the corresponding signal lines D1, D3, D5, D7, D9. Further, the pixel voltage generating module 3 within the pixel voltage generating module/2D making module 22 generates V2, V4, V6, and V8 from the pixel voltages V1, V3, V5, V7, and V9 outputted from the image signal source 2. The generated V2, V4, V6, and V8 are written to the 2nd, 4th, 6th, and 8th-viewpoint sub-pixels via the corresponding signal lines D2, D4, D6, and D8. In this manner, the voltages of V1 to V9 are written to the 1st to 9th-viewpoint sub-pixels, respectively.
In the meantime, in Mode 2 (2D mode), the second switch group 24 is electrically connected and the first switch group 23 is shutdown to write only the pixel voltage V5 among the outputs V1, V3, V5, V7, and V9 of the image signal source 2 to the 1st to 9th-viewpoint sub-pixels 6 via all the signal lines corresponding to the sub-pixels.

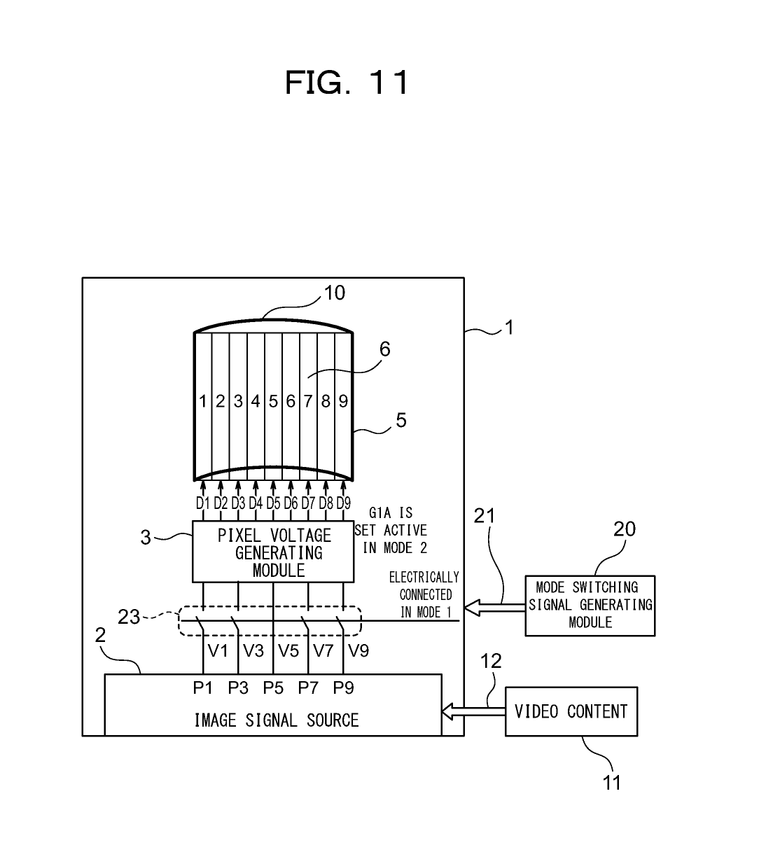

In FIG. 10, the second switch group 24 is shown as an independent structure. However, the second switch group 24 can also be achieved by the pixel voltage generating module 3 within the pixel voltage generating module/2D making module 22. For example, it can be achieved by using the switch S2c or the like of the pixel voltage generating module 3 shown in the second exemplary embodiment. An example of such structure is shown in FIG. 11.

In FIG. 11, the function of the second switch group 24 shown in FIG. 10 is designed to be executed by the pixel voltage generating module 3. The action thereof is as follows. In Mode 2 (2D mode), the switches S2a, S2b, and S2c are electrically connected simultaneously by synchronizing the gate signal G1A of the switch Sc2 shown in FIG. 4 of the second exemplary embodiment with another gate signal G1. As a result, for example, the neighboring signal lines D1 and D3 short-circuit (a case where X=2). Through short-circuiting D3 and D5, D5 and D7, and D7 and D9 by the same procedure, all the lines from D1 to D9 are short-circuited to achieve the function of the second switch group 24.
Further, in Mode 1 (intermediate voltage generation mode), the gate signal G1A of the switch Sc2 may be set as the signal that does not become active simultaneously with the gate signal G1 as in the case of the second exemplary embodiment.

Next, a sixth exemplary embodiment of the present invention will be described. A stereoscopic image display device disclosed in this exemplary embodiment includes a neighbor copy mode which sets the voltage to be written to the Xth-viewpoint sub-pixel 7, for example, out of N-pieces of sub-pixels for N-viewpoints to be in common to the voltage written to the neighboring “X−1”th viewpoint sub-pixel 8 or the “X+1”th viewpoint sub-pixel 9, in addition to the intermediate potential generation mode executed by the pixel voltage generating module 3 shown in the first to the fourth exemplary embodiment. The stereoscopic image display device is provided with a module for switching to one of the modes and a module which generates a signal for changing the mode.

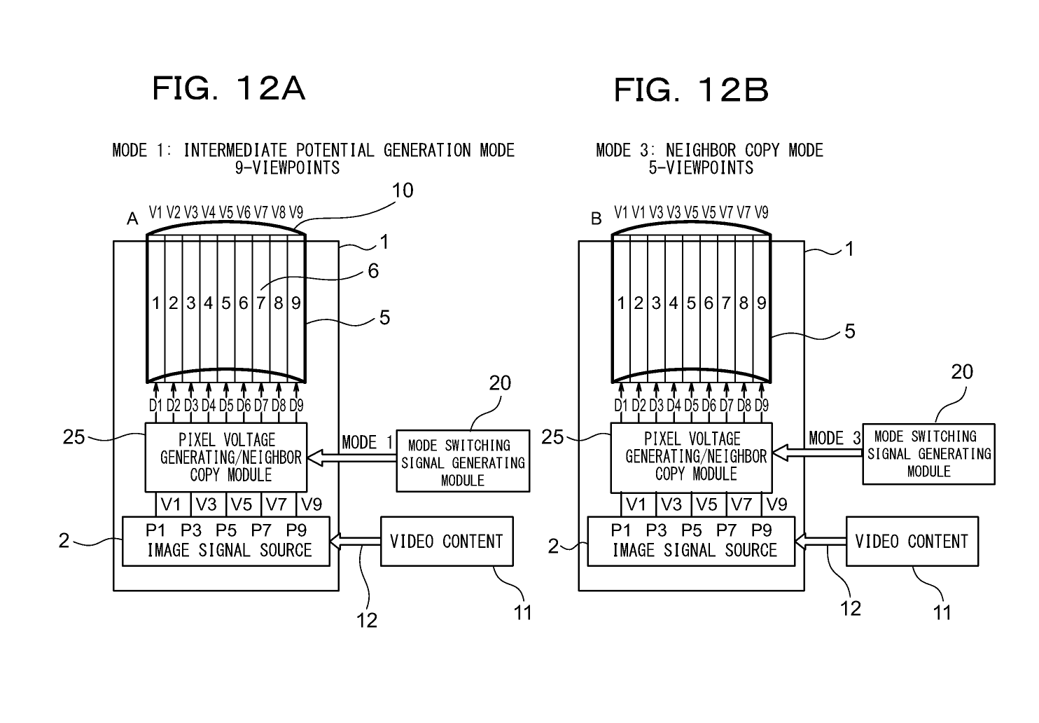

The stereoscopic image display device 1 shown in FIG. 12 is constituted with: a pixel voltage generating module/neighbor copy module (switching module) 25 which is connected to the image signal sources 2; and the 3D pixels 5 each constituted with the sub-pixels 6 of N-viewpoints, which are connected to those. FIG. 12 shows a case where the number N of viewpoints is 9. The module to be operated is switched between the pixel voltage generating module and the neighbor copy module in the pixel voltage generating module/neighbor copy module 25 by the mode switching signal outputted form the mode signal generating module 20. In mode 3 (neighbor copy mode), the voltage V2 written to the 2nd-viewpoint sub-pixel is set to be the same as V1 of the pixel voltage outputted from the image signal source by the neighbor copy module. Similarly, V4 is set to be same as V3, V6 as V5, and V8 as V7 to write the voltages from V1 to V9 to the 1st to 9th-viewpoint sub-pixels, respectively. In a case of the neighbor copy mode, V1, V3, V5, V7, and V9 outputted from the image signal source 2 are directly written to each of the viewpoint sub-pixels.
In Mode 1 shown in FIG. 12A (case of intermediate voltage generation mode) is the same as that of the fifth exemplary embodiment, so that explanations thereof are omitted. In the above, it is described that the voltage copied to the 2nd-viewpoint sub-pixel is the voltage written to the 1st-viewpoint sub-pixel. However, it is also possible to copy the voltage written to the 3rd-viewpoint sub-pixel. That is, it is a structure in which the voltage copied to the Xth-viewpoint sub-pixel is not the voltage written to the “X−1”th viewpoint sub-pixel but the voltage written to the “X+1”th viewpoint sub-pixel.
In the case of the neighbor copy mode shown in FIG. 12B, the pixel voltages to be written are limited to V1, V3, V5, V7, and V9 even though there are sub-pixels for 9-viewpoints, and the effective viewpoints are decreased to 5-viewpoints. That is, the neighbor copy works to decrease the number of effective viewpoints.

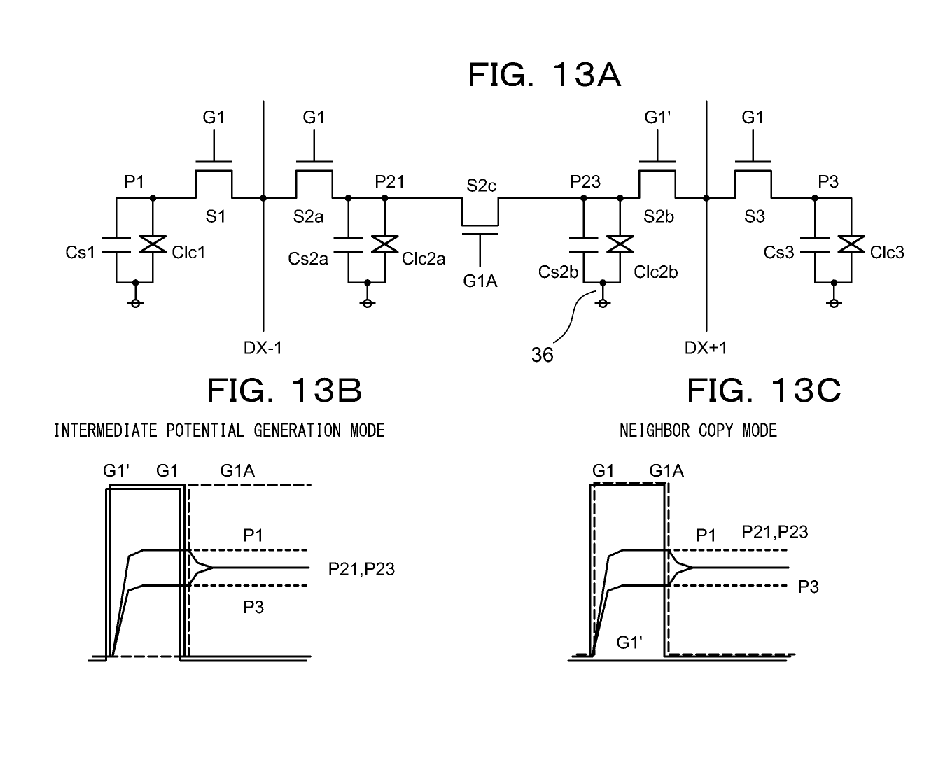

Next, as an example of the neighbor copy module, a structural example of a sub-pixel provided with the functions of neighbor copy and intermediate potential generation is shown in FIG. 13A.

While the circuit structure is the same as the sub-pixel of the second exemplary embodiment, there is a feature in its driving method. For allowing the intermediate potential generation to function, the gate signal waveform is set as shown in FIG. 13B, the gate signal G1 of the first switch S2a which links the signal line DX−1 corresponding to the “X−1”th viewpoint sub-pixel to the first pixel capacitance is synchronized with the gate signal GF of the second switch S2b which links the signal line DX+1 corresponding to the “X+1”th viewpoint sub-pixel to the second pixel capacitance, and those are not set active simultaneously with the gate signal G1A of the third switch S2c that is for balancing the potentials of the first pixel capacitance and the second pixel capacitance (electrical connection of the third switch and electrical connection of the first, second switches are not executed simultaneously).
In the meantime, when allowing the neighbor copy to function, the gate signal waveform is set as in FIG. 13C, the gate signal GF of the second switch S2b is set inactive at all times, and the gate signal G1A of the third switch S2c is synchronized with the gate signal G1 of the first switch S2a instead (electrical connection of the first switch and electrical connection of the third switch are executed simultaneously, while the second switch is shut down). The switch S2c and the switch S2a are electrically connected simultaneously by the drive of the gate signals, so that the pixel voltage Va written to the “X−1”th viewpoint sub-pixel 8 via the signal line DX−1 is also written to the capacitances Clc2b, Cs2b like the capacitance Clc2a, Cs2a. That is, Va is written to the Xth-viewpoint sub-pixel 7. In the meantime, the pixel voltage Vb written to the “X+1”th viewpoint sub-pixel 9 via the signal line DX+1 does not contribute to the Xth-viewpoint sub-pixel 7 since the switch S2b is shut down at all times.
Further, with the structure of the circuit diagram shown in FIG. 13A, through setting the gate signal of the switch S2a as G1 to be changed with the gate signal G1′ of the switch S2b and using the gate signal waveforms shown in FIGS. 13B and 13C, the voltage copied to the Xth-viewpoint sub-pixel 7 can be changed to the pixel voltage Vb written to the “X+1”th viewpoint sub-pixel 9 via the signal line DX+1. That is, it is possible to select the voltage to be copied to the Xth-viewpoint sub-pixel 7 from the pixel voltage Va written to the “X−1”th viewpoint sub-pixel 8 via the signal line DX−1 and the pixel voltage Vb written to the “X+1”th viewpoint sub-pixel 9 via the signal line DX+1 depending on whether or not the gate signals of the switch S2a and the switch S2b are synchronized with the gate signal G1A of the switch S2c. For example, by alternately switching the “X−1”th viewpoint sub-pixel 8 and the “X+1”th viewpoint sub-pixel 9 to be copied from every time one frame of the screen is rewritten or every time one line is rewritten, it is possible to provide a display screen where deviation is suppressed.

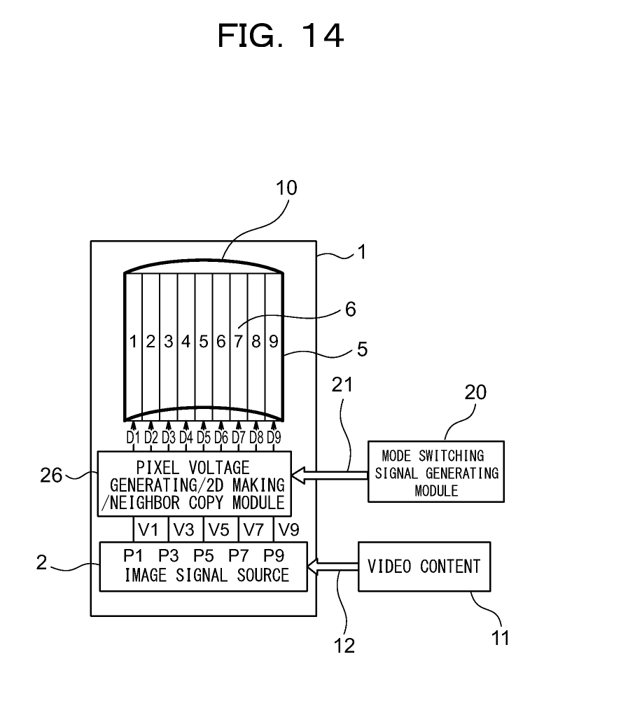

Next, a seventh exemplary embodiment of the present invention will be described by using a block diagram shown in FIG. 14. The stereoscopic image display device shown in FIG. 14 includes the intermediate potential generation mode shown in the second exemplary embodiment, the neighbor copy mode shown in the sixth exemplary embodiment, and the 2D mode shown in the fifth exemplary embodiment, and it is provided with a pixel voltage generating/2D making/neighbor copying module (switching module) 26 which switches the modes, and a mode switching signal generating module 20 which generates signals for switching the mode.

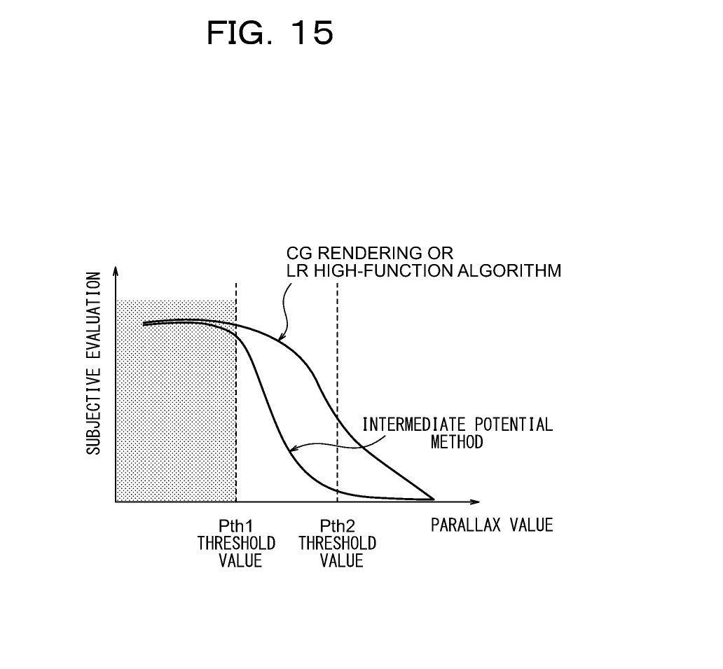

An external input module for changing the modes may be provided to the mode switching signal generating module 20 depicted in the fifth to seventh exemplary embodiments, and the observer may set the mode arbitrarily.
Further, the parallax value between the viewpoint images may be utilized as the materials for deciding which of the modes to be selected from Mode 1 to Mode 3. That is, it is possible to acquire the parallax value between the viewpoint images by using a parallax detecting module and change the mode according to the value. Based on the relation between the parallax values (lateral axis) between the viewpoint images and the subjective evaluations (longitudinal axis) of the stereoscopic image observer, in a case where the parallax value of the image data to be displayed is small (parallax value is Pth1 or smaller), the increase in the number of viewpoints by the intermediate potential (intermediate potential method in the chart) compares favorably with the increase in the number of viewpoints by other algorithms (CG rendering or LR high-function algorithm in FIG. 15). Thus, as the mode, Mode 1 (intermediate potential generation mode) can be selected. In a case of intermediate-level parallax value (in a case where the parallax value is between Pth1 and Pth2), there is a decrease observed in the result of the subjective evaluation with the increase in the viewpoints by the intermediate potential. Thus, it is possible to select Mode 3 (neighbor copy mode) which stops the increase in the number of viewpoints by the intermediate potential. This is because the effect with which the deterioration of the image quality based on the subjective evaluation can be eased when the number of viewpoints is smaller, in a case where the parallax values are equivalent. Further, in a case where the parallax value is large (a case where the parallax value is Pth2 or larger), it is judged that the result of the subjective evaluation is remarkably decreased with the increase in the number of viewpoints by the intermediate potential and that a fine image quality cannot be maintained. Thus, it is possible to select to change to Mode 2 (2D mode).
For detecting the parallax, parallax values may be added in advance to the information of a plurality of viewpoint images inputted to the stereoscopic image display device and may be used. It is also possible to detect a feature point from an arbitrary viewpoint image out of the plurality of viewpoint images inputted to the stereoscopic image display device, search corresponding point which corresponds to the feature point from another viewpoint image, and use the parallax value detected from the pixel position of the corresponding point. Furthermore, it is also possible to calculate a luminance difference value between a plurality of viewpoint images inputted to the stereoscopic image display device, and detect the parallax value by comparing the difference value and the luminance threshold value set in advance. Detection of the parallax executed in the exemplary embodiment is targeted to judge whether the parallax value between the plurality of viewpoint images is equal to or larger than the threshold value Pth1 or Pth2. Thus, it is not necessary to calculate all the parallax values between the plurality of viewpoint images. When a parallax value exceeding the threshold value is detected from the plurality of viewpoint images, the parallax value calculation processing may be stopped.

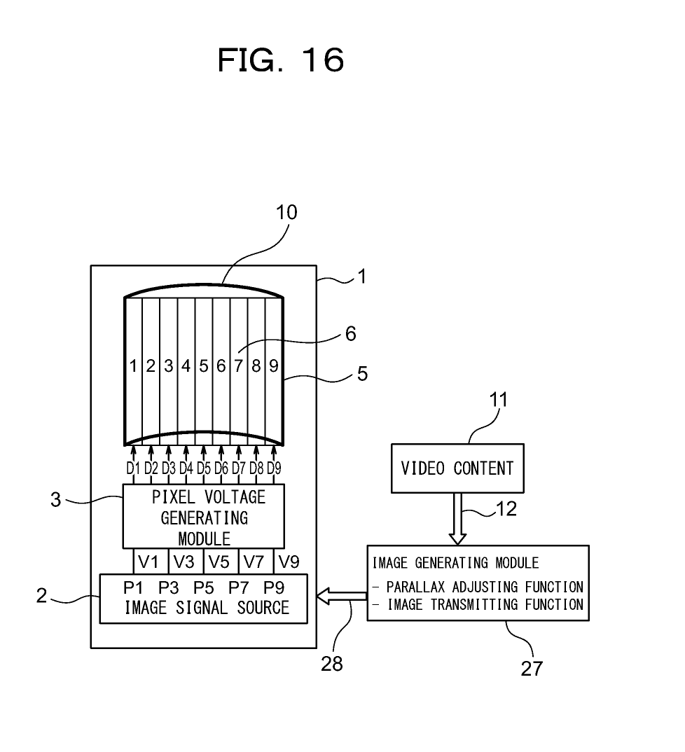

Next, an eighth exemplary embodiment of the present invention will be described by referring to a block diagram shown in FIG. 16. It is a feature of this exemplary embodiment to include an image generating module 27. The image generating module 27 includes: a parallax adjusting function which receives each viewpoint image transmitted to the stereoscopic image display device 1 and converts the parallax values between each of the viewpoint images into viewpoint images smaller than a parallax threshold value set in advance; and an image transmitting function which transmits each of the parallax-adjusted viewpoint images. The image generating module 27 detects in advance the parallax value of the plural-viewpoint image 12 as the video content 11, adjusts the parallax value of the plural-viewpoint image to the threshold value or smaller by the parallax adjusting function when the parallax value exceeds the parallax threshold value set in advance, and transmits an adjusted plural-viewpoint image 28 to the stereoscopic image display device 1. As shown in FIG. 15, for example, the parallax threshold value may be set to a parallax value with which the subjective evaluation is not deteriorated with increase in the number of viewpoints done by the intermediate potential. Further, the image generating module 27 also includes a plural-viewpoint image generating function for a case where a depth image is inputted as 3D image data. In that case, the parallax value of the plural-viewpoint image is generated so as not to exceed the parallax threshold value. Now, Japanese Unexamined Patent Publication 2009-103865 that is a related patent document regarding a multi-viewpoint stereoscopic image display device will be referred. In this related patent document, disclosed is a display information decreasing method when displaying a vast amount of display information of multi-viewpoint stereoscopic images on a 2-viewpoint stereoscopic image display device. In the meantime, it is the feature of the first to fourth exemplary embodiment of the present invention to increase the originally small amount of display information of the plural-viewpoint images to the image information for multi-viewpoints on the multi-viewpoint image display device side, which is different in terms of the structure and the object from those of the quoted patent document.

Further, in the fifth to seventh exemplary embodiment, described is a method which does not increase or a method which decreases the image information by keeping the display information inputted to the stereoscopic image display device with the neighbor copy mode or the 2D making mode. Each of those methods is different from the method of the related patent document. Further, the feature of this exemplary embodiment is to switch the first to fourth exemplary embodiments with the modes described above.

### Example 1

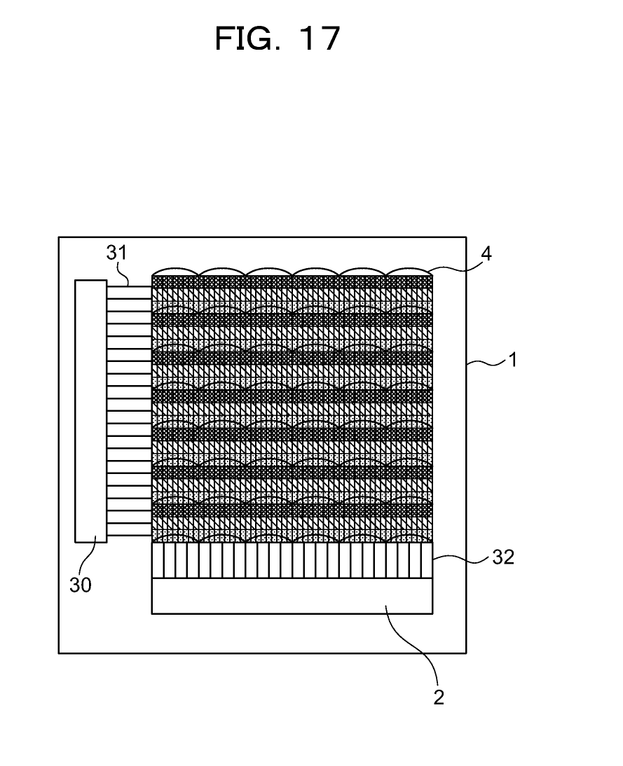

FIG. 17 shows a multi-viewpoint stereoscopic image display device 1 as Example of the present invention. The stereoscopic image display device 1 is constituted with: a pixel matrix 4 in which multi-viewpoint stereoscopic display pixels are arranged in matrix; an image signal source 2 which is connected via a part of signal wirings 32 provided within the pixel matrix 4; and a gate-line driving circuit 30 which is connected via a gate line 31. FIG. 17 shows a case of 9-viewpoints.

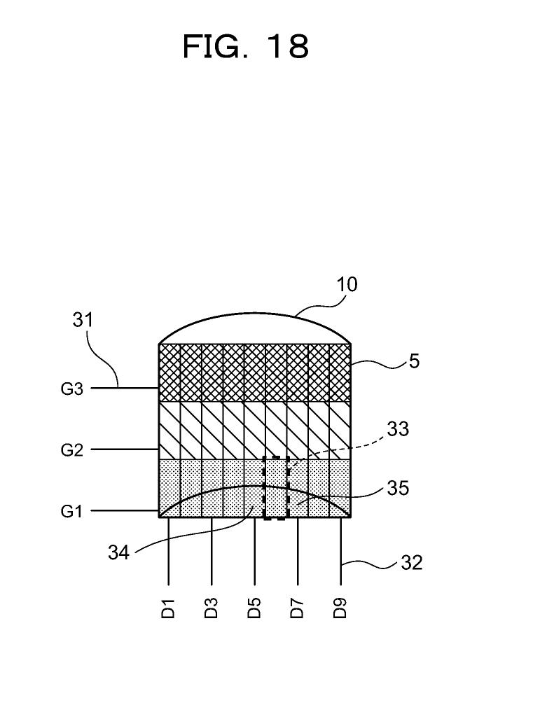

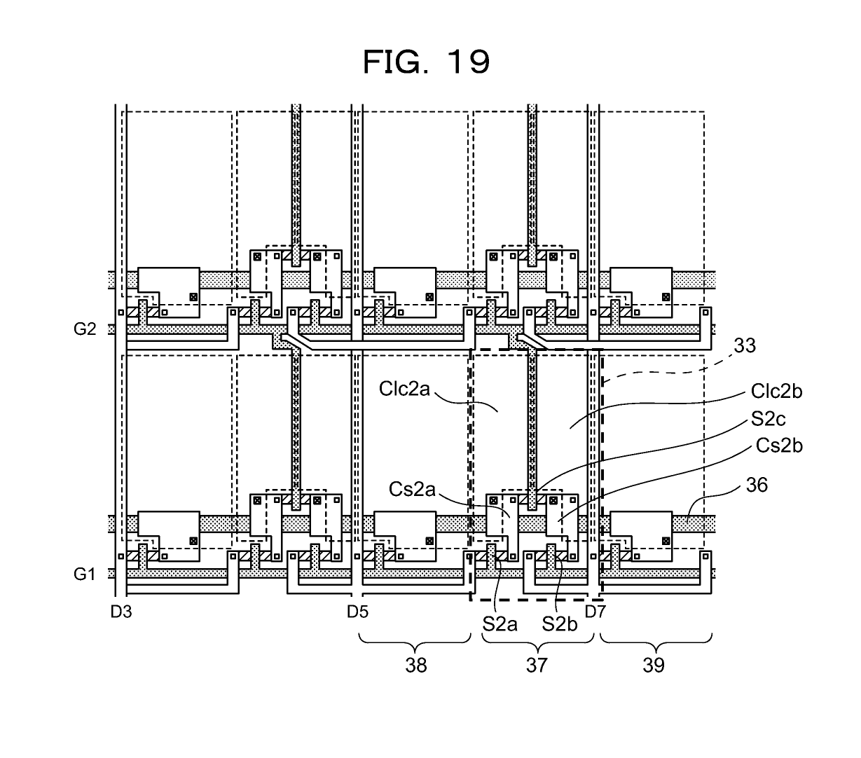

According to FIG. 18 which shows one 3D pixel 5 that constitutes the pixel matrix 4, the 3D pixel 5 is constituted with twenty-seven sub-pixels which are a combination of three colors of RGB 9-viewpoint sub-pixels with different color development. The signal lines D1, D3, D5, D7, and D9 are connected to the sub-pixels of corresponding viewpoint numbers, respectively, and the signal lines are not connected to the 2nd, 4th, 6th, and 8th-viewpoint sub-pixels.
FIG. 19 is a detailed diagram which shows a specific one-color (one out of R, G, and B) sub-pixel 33 of the 6th-viewpoint and the periphery thereof. The sub-pixel 33 shown herein achieves the sub-pixel circuit disclosed in the second exemplary embodiment. In FIG. 19, the storage capacitances Cs2a and Cs2b are formed between the common electrode 36 that is constituted with a first conductive layer and the storage capacitance electrode constituted with an insulated second conductor. The pixel capacitances Clc2a and Clc2b are formed between a transparent pixel electrode and a counter-substrate side transparent common electrode, not shown. The electronic switches S2a, S2b, and S2c are constituted with thin film transistors formed with a silicon thin film, for example, which are switching-controlled by the gate line G1 or G2 constituted with the first conductive layer and write the pixel voltages transmitted via the signal lines D5, D7 constituted with the second conductive layer to the storage capacitances Cs2a, Cs2b and the pixel capacitances Clc2a, Clc2b.
The storage capacitances Cs2a, Cs2b, the pixel capacitances Clc2a, Clc2b, and aperture parts formed by the transparent pixel electrode of the specific one-color sub-pixel of the 6th-viewpont separated into two in FIG. 19 function as one sub-pixel by being combined into one. Thus, by setting the total of those separated ones to be equivalent to the storage capacitances, the pixel capacitances, and the aperture parts of the specific one-color sub-pixels 34 and 35 of the neighboring 5th and 7th-viewpoints, it is possible to suppress generation of display unevenness between the sub-pixels.
While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.
While a part of or a whole part of the above-described exemplary embodiments can be depicted as following Supplementary Notes, the present invention is not limited only to the following structures.

### (Supplementary Note 1)

A stereoscopic image display device includes pixels each having N-pieces (N is a natural number satisfying N≧3) of sub-pixels corresponding to N-pieces of viewpoints arranged in matrix, wherein:

an “X−1”th viewpoint sub-pixel that is one stage before an Xth-viewpoint sub-pixel (X is a natural number satisfying 2≦X≦N−1) is connected to an image signal source via a corresponding signal line;

an “X+1”th viewpoint sub-pixel that is one stage after the Xth-viewpoint sub-pixel is connected to the image signal source via a signal line that is different from the signal line corresponding to the “X−1”th viewpoint sub-pixel;

voltages corresponding to a prescribed image signal are written and held to the “X−1”th viewpoint sub-pixel and the “X+1”th viewpoint sub-pixel from the image signal source; and

a voltage that is generated by a pixel voltage generating module by using the voltage written to the “X−1”th viewpoint sub-pixel and the voltage written to the “X+1”th viewpoint sub-pixel is written to the Xth-viewpoint sub-pixel.

### (Supplementary Note 2)

The stereoscopic image display device as depicted in Supplementary Note 1, wherein

the pixel voltage generating module generates an intermediate potential of the voltage written to the “X−1”th viewpoint sub-pixel and the voltage written to the “X+1”th viewpoint sub-pixel.

### (Supplementary Note 3)

The stereoscopic image display device as depicted in Supplementary Note 1 or 2, wherein

the pixel voltage generating module is provided inside the Xth-viewpoint sub-pixel, and includes:

a first switch which links the signal line that is connected to the “X−1”th viewpoint sub-pixel to an electrode of a first pixel capacitance of the Xth-viewpoint sub-pixel;

a second switch which links the signal line that is connected to the “X+1”th viewpoint sub-pixel to an electrode of a second pixel capacitance of the Xth-viewpoint sub-pixel; and

a third switch which links the electrode of the first pixel capacitance to the electrode of the second pixel capacitance and balances potentials of the electrodes of the first and the second pixel capacitances.

### (Supplementary Note 4)

The stereoscopic image display device as depicted in Supplementary Note 1 or 2, wherein

the pixel voltage generating module is provided inside the Xth-viewpoint sub-pixel, and includes:

a first switch which links the signal line that is connected to the “X−1”th viewpoint sub-pixel to a first electrode of a first pixel capacitance of the Xth-viewpoint sub-pixel;

a second switch which links the first electrode to a common electrode;

a third switch which links a second electrode of the first pixel capacitance different from the first electrode to the common electrode;

a fourth switch which links the signal line that is connected to the “X+1”th viewpoint sub-pixel to a third electrode of a second pixel capacitance of the Xth-viewpoint sub-pixel;

a fifth switch which links the third electrode to the common electrode;

a sixth switch which links a fourth electrode of the second pixel capacitance different from the third electrode to the common electrode; and

a seventh switch which links the second electrode to the fourth electrode and balances potentials of the second electrode and the fourth electrode.

### (Supplementary Note 5)

The stereoscopic image display device as depicted in Supplementary Note 1 or 2, wherein

the pixel voltage generating module is provided inside the Xth-viewpoint sub-pixel, and includes:

a first switch which links the signal line that is connected to the “X−1”th viewpoint sub-pixel to a first electrode of a first pixel capacitance of the Xth-viewpoint sub-pixel;

a second switch which links the first electrode to a common electrode;

a third switch which links a second electrode of the first pixel capacitance different from the first electrode to the common electrode;

a fourth switch which links the signal line that is connected to the “X+1”th viewpoint sub-pixel to a third electrode of a second pixel capacitance of the Xth-viewpoint sub-pixel; and

a fifth switch which links the second electrode to the third electrode and balances potentials of the second electrode and the third electrode.

### (Supplementary Note 6)

The stereoscopic image display device as depicted in any one of Supplementary Notes 1 to 5 includes:

a switching module which switches an intermediate potential generation mode which writes the intermediate potential to the Xth-viewpoint sub-pixel by the pixel voltage generating module from the voltage written to the “X−1”th viewpoint sub-pixel and the voltage written to the “X+1”th viewpoint sub-pixel and a 2D mode which takes a signal line selected among the signal lines connected to the image signal source within the N-pieces of viewpoints as the signal line connected to a Cth-viewpoint sub-pixel (C is a natural number satisfying 1≦C≦N) and writes a Cth-viewpoint sub-pixel voltage to all the viewpoint sub-pixels; and

a mode switching signal generating module which generates a mode switching signal to be inputted to the switching module.

### (Supplementary Note 7)

The stereoscopic image display device as depicted in Supplementary Note 6, wherein

C in the Cth-viewpoint sub-pixel is a natural number that is closest to N/2.

### (Supplementary Note 8)

The stereoscopic image display device as depicted in Supplementary Note 6 or 7, wherein

the switching module at least includes a switch which links a signal line other than the signal line connected to the Cth-viewpoint sub-pixel to a corresponding output end of the image signal source, becomes electrically connected in the intermediate potential generation mode, and is shut down in the 2D mode.

### (Supplementary Note 9)

The stereoscopic image display device as depicted in Supplementary Note 6, wherein

the switching module at least includes a switch which connects all the signal lines within the pixel mutually, is shut down in the intermediate potential generation mode, and becomes electrically connected in the 2D mode.

### (Supplementary Note 10)

The stereoscopic image display device as depicted in any one of Supplementary Notes 1 to 5 includes:

a switching module which switches an intermediate potential generation mode which writes the intermediate potential to the Xth-viewpoint sub-pixel by the pixel voltage generating module from the voltage written to the “X−1”th viewpoint sub-pixel and the voltage written to the “X+1”th viewpoint sub-pixel and a neighbor copy mode which writes a voltage same as the voltage written to the “X−1”th viewpoint sub-pixel or the voltage written to the “X+1”th viewpoint sub-pixel to the Xth-viewpoint sub-pixel; and

a mode switching signal generating module which generates a mode switching signal to be inputted to the switching module.

### (Supplementary Note 11)

The stereoscopic image display device as depicted in Supplementary Note 4 includes:

a switching module which switches an intermediate potential generation mode which writes the intermediate potential to the Xth-viewpoint sub-pixel by the pixel voltage generating module from the voltage written to the “X−1”th viewpoint sub-pixel and the voltage written to the “X+1”th viewpoint sub-pixel and a neighbor copy mode which writes a voltage same as the voltage written to the “X−1”th viewpoint sub-pixel or the voltage written to the “X+1”th viewpoint sub-pixel to the Xth-viewpoint sub-pixel; and

a mode switching signal generating module which generates a mode switching signal to be inputted to the switching module, wherein

the switching module is a module which generates gate signals for the first, second, and third switches for not executing electrical connection of the third switch and electrical connection of the first and second switches of the pixel voltage generating module simultaneously in the intermediate potential generation mode, and for executing electrical connection of the first and third switches simultaneously and for shutting down the second switch in the neighbor copy mode.

### (Supplementary Note 12)

The stereoscopic image display device as depicted in any one of Supplementary Notes 1 to 5 includes:

a switching module which switches an intermediate potential generation mode which writes the intermediate potential to the Xth-viewpoint sub-pixel by the pixel voltage generating module from the voltage written to the “X−1”th viewpoint sub-pixel and the voltage written to the “X+1”th viewpoint sub-pixel, a neighbor copy mode which writes a voltage same as the voltage written to the “X−1”th viewpoint sub-pixel or the voltage written to the “X+1”th viewpoint sub-pixel to the Xth-viewpoint sub-pixel, and a 2D mode which takes a signal line selected among the signal lines connected to the image signal source within the N-pieces of viewpoints as the signal line connected to a Cth-viewpoint sub-pixel and writes a Cth-viewpoint sub-pixel voltage to all the viewpoint sub-pixels; and

a mode switching signal generating module which generates a mode switching signal to be inputted to the switching module.

### (Supplementary Note 13)

The stereoscopic image display device as depicted in any one of Supplementary Notes 6 to 12, wherein the mode switching signal generating module generates the mode switching signal by using an external input module that can be set arbitrarily by an observer.

### (Supplementary Note 14)

The stereoscopic image display device as depicted in any one of Supplementary Notes 6 to 12, wherein the mode switching signal generating module generates the mode switching signal by using a parallax detection module which detects a parallax value between a plurality of viewpoint images.

### (Supplementary Note 15)

The stereoscopic image display device as depicted in Supplementary Note 14, wherein

the parallax detecting module detects parallax values attached in advance to the viewpoint images.

### (Supplementary Note 16)

The stereoscopic image display device as depicted in Supplementary Note 14, wherein

the parallax detecting module detects a feature point from an arbitrary viewpoint image, searches a corresponding point that corresponds to the feature point from another viewpoint image, and detects the parallax value from a pixel position of the corresponding point.

### (Supplementary Note 17)

The stereoscopic image display device as depicted in Supplementary Note 14, wherein

the parallax detecting module calculates a luminance difference value between the plurality of viewpoint images, and compares the luminance difference value with a luminance threshold value set in advance to detect the parallax value.

### (Supplementary Note 18)

The stereoscopic image display device as depicted in any one of Supplementary Notes 1 to 5, wherein the voltages written to the “X−1”th viewpoint sub-pixel and to the “X+1”th viewpoint sub-pixel are voltages corresponding to an image signal having a smaller parallax value than a parallax threshold value set in advance by an image generating module.

### (Supplementary Note 19)

The stereoscopic image display device as depicted in Supplementary Note 18, wherein

the image generating module includes: a parallax adjusting function which receives each of viewpoint images transmitted to the stereoscopic image display device and converts the received images to viewpoint images in which the parallax value between each of the viewpoint images is smaller than the parallax threshold value set in advance by the image generating module; and an image transmitting function which transmits an image signal having a parallax value smaller than the parallax threshold value set in advance.

### INDUSTRIAL APPLICABILITY

The present invention can also be applied to a stereoscopic image processing system which includes a function of generating multi-viewpoint images from plural-viewpoint images by using a stereoscopic display panel. Note that the present invention is not limited only to the exemplary embodiments described above, and various changes are possible without departing form the scope of the present invention. For example, a case of replacing the liquid crystal pixels shown in the exemplary embodiments to electroluminescence pixels (EL pixels) can be considered. In the case of the liquid crystal pixels, the luminance of the pixels is controlled by the voltage applied thereto, and it is stored in the storage capacitance. In the meantime, the luminance of the EL pixels is controlled by the electric current flown thereto, and it is normally adjusted by the storage voltage of the current mirror circuit. A capacitance element is used for storing the voltage. Therefore, by replacing it to the storage capacitance of the exemplary embodiments, the exemplary embodiment can be applied to the EL display device.

What is claimed is:

1. A stereoscopic image display device, comprising pixels each having N-pieces (N is a natural number satisfying N≧3) of sub-pixels corresponding to N-pieces of viewpoints arranged in matrix, wherein:
an “X−1”th viewpoint sub-pixel that is one stage before an Xth-viewpoint sub-pixel (X is a natural number satisfying 2≦X≦N−1) is connected to an image signal source via a corresponding signal line;
an “X+1”th viewpoint sub-pixel that is one stage after the Xth-viewpoint sub-pixel is connected to the image signal source via a signal line that is different from the signal line corresponding to the “X−1”th viewpoint sub-pixel;
voltages corresponding to a prescribed image signal are written and held to the “X−1”th viewpoint sub-pixel and the “X+1”th viewpoint sub-pixel from the image signal source; and
a voltage that is generated by a pixel voltage generating module by using the voltage written to the “X−1”th viewpoint sub-pixel and the voltage written to the “X+1”th viewpoint sub-pixel is written to the Xth-viewpoint sub-pixel.

2. The stereoscopic image display device as claimed in claim 1, wherein
the pixel voltage generating module generates an intermediate potential of the voltage written to the “X−1”th viewpoint sub-pixel and the voltage written to the “X+1”th viewpoint sub-pixel.

3. The stereoscopic image display device as claimed in claim 1, wherein
the pixel voltage generating module is provided inside the Xth-viewpoint sub-pixel, and comprises:
a first switch which links the signal line that is connected to the “X−1”th viewpoint sub-pixel to an electrode of a first pixel capacitance of the Xth-viewpoint sub-pixel;
a second switch which links the signal line that is connected to the “X+1”th viewpoint sub-pixel to an electrode of a second pixel capacitance of the Xth-viewpoint sub-pixel; and
a third switch which links the electrode of the first pixel capacitance to the electrode of the second pixel capacitance and balances potentials of the electrodes of the first and the second pixel capacitances.

4. The stereoscopic image display device as claimed in claim 2, wherein
the pixel voltage generating module is provided inside the Xth-viewpoint sub-pixel, and comprises:
a first switch which links the signal line that is connected to the “X−1”th viewpoint sub-pixel to an electrode of a first pixel capacitance of the Xth-viewpoint sub-pixel;
a second switch which links the signal line that is connected to the “X+1”th viewpoint sub-pixel to an electrode of a second pixel capacitance of the Xth-viewpoint sub-pixel; and
a third switch which links the electrode of the first pixel capacitance to the electrode of the second pixel capacitance and balances potentials of the electrodes of the first and the second pixel capacitances.

5. The stereoscopic image display device as claimed in claim 1, wherein
the pixel voltage generating module is provided inside the Xth-viewpoint sub-pixel, and comprises:
a first switch which links the signal line that is connected to the “X−1”th viewpoint sub-pixel to a first electrode of a first pixel capacitance of the Xth-viewpoint sub-pixel;
a second switch which links the first electrode to a common electrode;
a third switch which links a second electrode of the first pixel capacitance different from the first electrode to the common electrode;
a fourth switch which links the signal line that is connected to the “X+1”th viewpoint sub-pixel to a third electrode of a second pixel capacitance of the Xth-viewpoint sub-pixel;
a fifth switch which links the third electrode to the common electrode;
a sixth switch which links a fourth electrode of the second pixel capacitance different from the third electrode to the common electrode; and
a seventh switch which links the second electrode to the fourth electrode and balances potentials of the second electrode and the fourth electrode.

6. The stereoscopic image display device as claimed in claim 1, wherein
the pixel voltage generating module is provided inside the Xth-viewpoint sub-pixel, and comprises:
a first switch which links the signal line that is connected to the “X−1”th viewpoint sub-pixel to a first electrode of a first pixel capacitance of the Xth-viewpoint sub-pixel;
a second switch which links the first electrode to a common electrode;
a third switch which links a second electrode of the first pixel capacitance different from the first electrode to the common electrode;
a fourth switch which links the signal line that is connected to the “X+1”th viewpoint sub-pixel to a third electrode of a second pixel capacitance of the Xth-viewpoint sub-pixel; and
a fifth switch which links the second electrode to the third electrode and balances potentials of the second electrode and the third electrode.

7. The stereoscopic image display device as claimed in claim 2, comprising:
a switching module which switches an intermediate potential generation mode which writes the intermediate potential to the Xth-viewpoint sub-pixel by the pixel voltage generating module from the voltage written to the “X−1”th viewpoint sub-pixel and the voltage written to the “X+1”th viewpoint sub-pixel and a 2D mode which takes a signal line selected among the signal lines connected to the image signal source within the N-pieces of viewpoints as the signal line connected to a Cth-viewpoint sub-pixel (C is a natural number satisfying 1≦C≦N) and writes a Cth-viewpoint sub-pixel voltage to all the viewpoint sub-pixels; and
a mode switching signal generating module which generates a mode switching signal to be inputted to the switching module.

8. The stereoscopic image display device as claimed in claim 7, wherein
C in the Cth-viewpoint sub-pixel is a natural number that is closest to N/2.

9. The stereoscopic image display device as claimed in claim 7, wherein
the switching module at least comprises a switch which links a signal line other than the signal line connected to the Cth-viewpoint sub-pixel to a corresponding output end of the image signal source, becomes electrically connected in the intermediate potential generation mode, and is shut down in the 2D mode.

10. The stereoscopic image display device as claimed in claim 7, wherein
the switching module at least comprises a switch which connects all the signal lines within the pixel mutually, is shut down in the intermediate potential generation mode, and becomes electrically connected in the 2D mode.

11. The stereoscopic image display device as claimed in claim 2, comprising:
a switching module which switches an intermediate potential generation mode which writes the intermediate potential to the Xth-viewpoint sub-pixel by the pixel voltage generating module from the voltage written to the “X−1”th viewpoint sub-pixel and the voltage written to the “X+1”th viewpoint sub-pixel and a neighbor copy mode which writes a voltage same as the voltage written to the “X−1”th viewpoint sub-pixel or the voltage written to the “X+1”th viewpoint sub-pixel to the Xth-viewpoint sub-pixel; and
a mode switching signal generating module which generates a mode switching signal to be inputted to the switching module.

12. The stereoscopic image display device as claimed in claim 4, comprising:
a switching module which switches an intermediate potential generation mode which writes the intermediate potential to the Xth-viewpoint sub-pixel by the pixel voltage generating module from the voltage written to the “X−1”th viewpoint sub-pixel and the voltage written to the “X+1”th viewpoint sub-pixel and a neighbor copy mode which writes a voltage same as the voltage written to the “X−1”th viewpoint sub-pixel or the voltage written to the “X+1”th viewpoint sub-pixel to the Xth-viewpoint sub-pixel; and
a mode switching signal generating module which generates a mode switching signal to be inputted to the switching module, wherein
the switching module is a module which generates gate signals for the first, second, and third switches for not executing electrical connection of the third switch and electrical connection of the first and second switches of the pixel voltage generating module simultaneously in the intermediate potential generation mode, and for executing electrical connection of the first and third switches simultaneously and for shutting down the second switch in the neighbor copy mode.

13. The stereoscopic image display device as claimed in claim 2, comprising:
a switching module which switches an intermediate potential generation mode which writes the intermediate potential to the Xth-viewpoint sub-pixel by the pixel voltage generating module from the voltage written to the “X−1”th viewpoint sub-pixel and the voltage written to the “X+1”th viewpoint sub-pixel, a neighbor copy mode which writes a voltage same as the voltage written to the “X−1”th viewpoint sub-pixel or the voltage written to the “X+1”th viewpoint sub-pixel to the Xth-viewpoint sub-pixel, and a 2D mode which takes a signal line selected among the signal lines connected to the image signal source within the N-pieces of viewpoints as the signal line connected to a Cth-viewpoint sub-pixel and writes a Cth-viewpoint sub-pixel voltage to all the viewpoint sub-pixels; and
a mode switching signal generating module which generates a mode switching signal to be inputted to the switching module.

14. The stereoscopic image display device as claimed in claim 7, wherein the mode switching signal generating module generates the mode switching signal by using an external input module that can be set arbitrarily by an observer.

15. The stereoscopic image display device as claimed in claim 7, wherein the mode switching signal generating module generates the mode switching signal by using a parallax detection module which detects a parallax value between a plurality of viewpoint images.

16. The stereoscopic image display device as claimed in claim 15, wherein
the parallax detecting module detects parallax values attached in advance to the viewpoint images.

17. The stereoscopic image display device as claimed in claim 15, wherein
the parallax detecting module detects a feature point from an arbitrary viewpoint image, searches a corresponding point that corresponds to the feature point from another viewpoint image, and detects the parallax value from a pixel position of the corresponding point.

18. The stereoscopic image display device as claimed in claim 15, wherein
the parallax detecting module calculates a luminance difference value between the plurality of viewpoint images, and compares the luminance difference value with a luminance threshold value set in advance to detect the parallax value.

19. The stereoscopic image display device as claimed in claim 1, wherein the voltages written to the “X−1”th viewpoint sub-pixel and to the “X+1”th viewpoint sub-pixel are voltages corresponding to an image signal having a smaller parallax value than a parallax threshold value set in advance by an image generating module.

20. The stereoscopic image display device as claimed in claim 19, wherein
the image generating module comprises: a parallax adjusting function which receives each of viewpoint images transmitted to the stereoscopic image display device and converts the received images to viewpoint images in which the parallax value between each of the viewpoint images is smaller than the parallax threshold value set in advance by the image generating module; and an image transmitting function which transmits an image signal having a parallax value smaller than the parallax threshold value set in advance.
